(19) United States
(12) Patent Application Publication
(10) Pub. No.: US 2026/0220851 A1
(43) Pub. Date: Jul. 30, 2026

(54) AUTOMATED WEBSITE GENERATION USING COMMODITY IDENTIFIERS

(71) Applicant: Tertulia, Inc., Brooklyn, NY (US)

(72) Inventors: Sebastian Cwilich, Brooklyn, NY (US); Mauricio Grijalba, Ciudad Autónoma de Buenos Aires (AR); Lynda Hammes, Brooklyn, NY (US); Daniel Kux, Beccar (AR); Robert Lenne, Gustavsberg (SE); Martin Zavatto, La Lucila (AR); Nicolas Cristian Gonzalez, Floencio Varela (AR)

(21) Appl. No.: 19/458,444

(22) Filed: Jan. 23, 2026

Related U.S. Application Data
(60) Provisional application No. 63/749,119, filed on Jan. 24, 2025.

(51) Int. Cl. G06T 11/60; G06F 40/174; G06F 40/253

(52) U.S. Cl. CPC G06T 11/60; G06F 40/174; G06F 40/253; G06T 2200/24

(57) ABSTRACT

An automated website generation system receives a unique book identifier for a book associated with an author and transmits a query via a computer network to one or more data sources for content associated with the unique book identifier. The system receives book-related information from the data sources in response to the query and automatically generates a custom website for the author based on the retrieved information. The custom website includes content derived from the book-related information without requiring manual entry by the user. The system may perform author disambiguation to identify information and additional books associated with the author by analyzing genre information, publication timing patterns, and publisher relationships for books having author names that match or are similar to the author, and determining whether the books should be associated with the author based on weighted confidence scores.

### CROSS-REFERENCE TO RELATED APPLICATIONS

This application claims the benefit of U.S. Provisional Application No. 63/749,119, filed Jan. 24, 2025, entitled “Online digital platform for automatic custom website development for authors”, and the entire contents of which are hereby incorporated herein by reference for all purposes.

### BACKGROUND

Websites serve as digital platforms for individuals and businesses to establish an online presence, share information, and engage with audiences. For authors, musicians, artists, and other content creators, websites provide a centralized location where fans and potential customers can learn about their work, access biographical information, view portfolios or catalogs, and make purchases. Similarly, merchants and retailers use websites to showcase and sell their products or commodities to customers, providing product information, pricing, and purchasing capabilities.

Website development typically involves multiple components including domain registration, hosting infrastructure, content management systems, visual design, and functional elements such as e-commerce integration and social media connectivity. Various approaches to website creation exist, ranging from custom coding by professional developers to template-based platforms that allow users to build sites through graphical interfaces.

### SUMMARY

Techniques are discussed herein to automate website generation using commodity identifiers. In certain embodiments, a computer-implemented method for automated website generation is provided, the method comprising: receiving, via a user interface, a unique book identifier for a book associated with an author; transmitting a query via a computer network to one or more data sources for content associated with the unique book identifier; receiving, in response to the query, book-related information from the one or more data sources; and automatically generating a custom website for the author based on the book-related information, wherein the custom website includes content derived from the book-related information.

In some embodiments, transmitting the query to the one or more data sources further comprises querying for author-associated content; receiving, in response to the query, the book-related information further comprises receiving author-related information from the one or more data sources; and automatically generating the custom website for the author is further based on the author-related information.

In certain embodiments, automatically generating the custom website comprises automatically selecting a website template from a plurality of available templates based on characteristics of the book identified in the book-related information.

In some embodiments, the method further comprises performing author disambiguation to identify one or more additional books associated with the author; and retrieving, from the one or more data sources, additional book-related information for the one or more additional books, wherein automatically generating the custom website for the author is further based on the additional book-related information.

In certain embodiments, performing author disambiguation comprises: analyzing genre information for books having author names that match or are similar to the author; analyzing publication timing patterns for books having author names that match or are similar to the author; analyzing publisher relationships for books having author names that match or are similar to the author; and determining whether the books should be associated with the author based on the analyzed genre information, publication timing patterns, and publisher relationships.

In some embodiments, determining whether the books should be associated with the author comprises: calculating a confidence score based on weighted contributions from the genre information, publication timing patterns, and publisher relationships; and associating books with the author when the confidence score exceeds a predetermined threshold.

In certain embodiments, the unique book identifier is an International Standard Book Number, a European Article Number, a book title, or a Uniform Resource Locator.

In some embodiments, the method further comprises analyzing author-generated content to identify a writing style of the author; and wherein automatically generating the custom website comprises automatically drafting website content components based on the writing style.

In certain embodiments, the method further comprises receiving, via the user interface, social media information associated with the author; and retrieving social media author-associated content from one or more social media platforms based on the social media information, wherein automatically generating the custom website for the author is further based on the social media content.

In some embodiments, automatically generating the custom website comprises: selecting a theme for the custom website based on the book-related information; determining a layout for the custom website including a plurality of sections comprising an author information section, and a book information section; populating the author information section with biographical information about the author retrieved from the one or more data sources; populating the book information section with book details including a title, description, and images associated with the book retrieved from the one or more data sources; generating purchase links in the book information section, wherein the purchase links direct visitors to one or more online retailers offering the book for sale; and configuring navigation elements to enable access to each of the plurality of sections.

In certain embodiments, the method further comprises generating a social media post recommendation based on at least one of (1) the book-related information, (2) author-related information retrieved from the one or more data sources, or (3) a social media profile of the author.

In another embodiment, a system for automated website generation is provided, the system comprising: a processor; and a memory storing instructions that, when executed by the processor, cause the system to: receive, via a user interface, a unique book identifier for a book associated with an author; transmit a query via a computer network to one or more data sources for content associated with the unique book identifier; receive, in response to the query, book-related information from the one or more data sources; and automatically generate a custom website for the author based on the book-related information, wherein the custom website includes content derived from the book-related information.

In some embodiments, the instructions further cause the system to: transmit the query to the one or more data sources by querying for author-associated content; receive author-related information from the one or more data sources in response to the query; and automatically generate the custom website for the author further based on the author-related information.

In certain embodiments, the instructions that cause the system to automatically generate the custom website further cause the system to automatically select a website template from a plurality of available templates based on characteristics of the book identified in the book-related information.

In some embodiments, the instructions further cause the system to: perform author disambiguation to identify one or more additional books associated with the author; and retrieve, from the one or more data sources, additional book-related information for the one or more additional books, wherein to automatically generate the custom website for the author is further based on the additional book-related information.

In certain embodiments, to perform author disambiguation comprises to: analyze genre information for books having author names that match or are similar to the author; analyze publication timing patterns for books having author names that match or are similar to the author; analyze publisher relationships for books having author names that match or are similar to the author; and determine whether the books should be associated with the author based on the analyzed genre information, publication timing patterns, and publisher relationships.

In some embodiments, the instructions further cause the system to analyze author-generated content to identify a writing style of the author; and wherein to automatically generate the custom website comprises to automatically draft website content components based on the writing style.

In certain embodiments, the instructions further cause the system to: receive, via the user interface, social media information associated with the author; and retrieve social media author-associated content from one or more social media platforms based on the social media information, wherein the custom website is generated further based on the social media content.

In some embodiments, the instructions that cause the system to automatically generate the custom website further cause the system to: select a theme for the custom website based on the book-related information; determine a layout for the custom website including a plurality of sections comprising an author information section and a book information section; populate the author information section with biographical information about the author retrieved from the one or more data sources; populate the book information section with book details including a title, description, and images associated with the book retrieved from the one or more data sources; generate purchase links in the book information section, wherein the purchase links direct visitors to one or more online retailers offering the book for sale; and configure navigation elements to enable access to each of the plurality of sections.

In yet another embodiment, a non-transitory computer-readable medium is provided storing instructions that, when executed by a processor, cause the processor to perform operations comprising: receiving, via a user interface, a unique book identifier for a book associated with an author; transmitting a query via a computer network to one or more data sources for content associated with the unique book identifier; receiving, in response to the query, book-related information from the one or more data sources; and automatically generating a custom website for the author based on the book-related information, wherein the custom website includes content derived from the book-related information

### BRIEF DESCRIPTION OF THE DRAWINGS

FIG. 1 is a block diagram illustrating a system architecture for automated website generation using commodity identifiers.

FIG. 2 is a flowchart illustrating a process for automated website generation based on commodity identifiers and optional user profile information.

FIG. 3 is a block diagram of an example of a user interface for receiving commodity identifier and optional social media information.

FIG. 4 illustrates examples of screenshots of theme selection options for website customization.

FIG. 5 illustrates an example of a user interface for configuring website design options prior to website generation.

FIG. 6 illustrates an example of a user interface displaying a generated website with configuration and publishing options.

FIG. 7 illustrates an example of a user interface for configuring user biographical information.

FIG. 8 illustrates an example of a user interface for configuring purchase links for commodities.

FIG. 9 illustrates an example of a commodity display page showing multiple commodities.

FIG. 10 illustrates an example of a user interface for editing individual commodity information.

FIG. 11 illustrates examples of automated social media post templates generated based on commodity information.

FIG. 12 is a block diagram illustrating infrastructure layers for a website generation system.

FIG. 13 is a flowchart illustrating an example of a method for automated website generation.

FIG. 14 is a block diagram of an example of a computing system suitable for implementing techniques discussed herein.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Websites serve as digital platforms for individuals and businesses to establish an online presence, share information, and engage with audiences. For authors, musicians, artists, and other content creators, websites provide a centralized location where fans and potential customers can learn about their work, access biographical information, view portfolios or catalogs, and make purchases. Similarly, merchants and retailers use websites to showcase and sell their products or commodities to customers, providing product information, pricing, and purchasing capabilities.

Website development typically involves multiple components including domain registration, hosting infrastructure, content management systems, visual design, and functional elements such as e-commerce integration and social media connectivity. Various approaches to website creation exist, ranging from custom coding by professional developers to template-based platforms that allow users to build sites through graphical interfaces.

Many individuals and small businesses seek to establish web presence for specific commodities or works they produce. For example, authors may desire websites featuring their published books, musicians may want sites showcasing their albums or performances, and product sellers may seek sites displaying their merchandise or inventory. These websites often include similar functional elements across users within the same category, such as product listings, purchase links, biographical or business information, media galleries, and contact methods.

Conventional website builders require users to manually input substantial amounts of information and make numerous design and organizational decisions. For example, users may be required to individually upload biographical information, product details, images, reviews, and other content elements. Users must navigate through multi-step wizards, select templates, configure layouts, and populate each section of their website through manual data entry. This process can be time-consuming and presents barriers to users seeking to establish web presence quickly. The manual nature of these platforms results in extended periods between initial user engagement and website completion.

Data about commodities, such as books, music, and other products, is often available through various digital sources and databases. Product identifiers, including International Standard Book Numbers (ISBNs) for books and similar standardized codes for other commodities, provide unique references that can be used to retrieve associated information from these sources. Additionally, social media platforms contain user-generated content and profile information that may be relevant to individuals seeking to establish comprehensive online presence.

The intersection of commodity identification systems, data sources, and web development technologies presents opportunities for automated approaches to website creation that leverage existing digital information infrastructure. Techniques discussed herein address challenges presented by conventional website builders and other website generation processes by providing automated website generation systems and methods that leverage commodity identifiers to retrieve and aggregate relevant information from multiple data sources. In certain embodiments, a user provides a commodity identifier (such as an ISBN, European Article Number (EAN), book title, or Uniform Resource Locator (URL) for books) and optionally a social media profile identifier. The system automatically queries multiple data sources to retrieve commodity-related information, user biographical information, images, reviews, and other relevant content. The system generates a complete, functional custom website based on the retrieved information in a matter of seconds, eliminating the need for extensive manual data entry and configuration. The system may further analyze the retrieved information to automatically recommend themes, layouts, and design elements tailored to the specific characteristics of the commodity and user. This automated approach enables rapid website deployment.

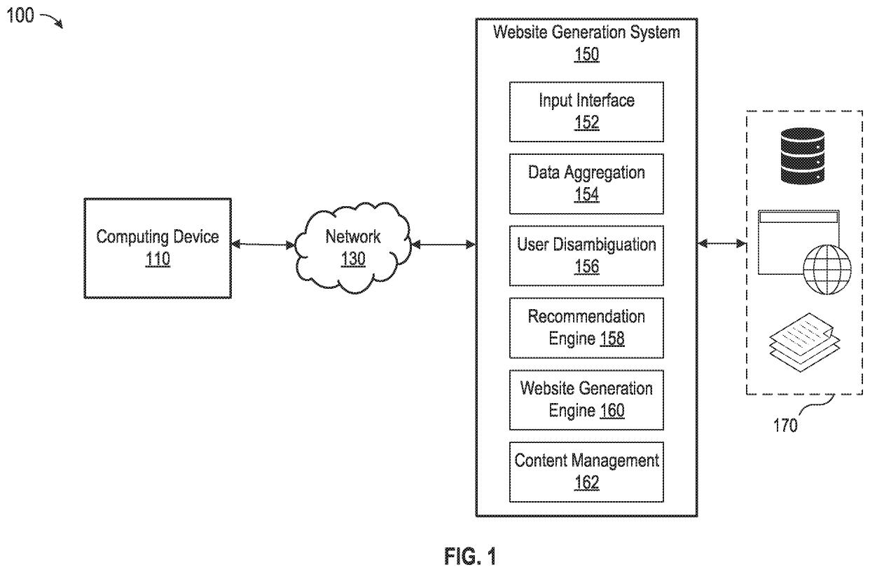

FIG. 1 illustrates a system architecture 100 for automated website generation using commodity identifiers. The architecture includes a computing device 110, a network 130, a website generation system 150, and data sources 170.

Computing device 110 represents a user device through which a user interacts with the website generation system 150. Computing device 110 may be a personal computer, laptop, tablet, smartphone, or other computing device capable of executing a web browser or dedicated application. In certain embodiments, computing device 110 includes a display for presenting user interfaces and input mechanisms (such as keyboard, mouse, or touchscreen) for receiving user input. Computing device 110 communicates with website generation system 150 via network 130.

Network 130 may comprise one or more networks including local area networks (LANs), wide area networks (WANs), the Internet, cellular networks, or combinations thereof. Network 130 facilitates data communication between computing device 110, website generation system 150, and data sources 170 using standard communication protocols such as HTTP, HTTPS, TCP/IP, or other suitable protocols.

Website generation system 150 comprises the core components for automated website creation based on commodity identifiers. In the illustrated embodiment, website generation system 150 includes an input interface module 152, a data aggregation module 154, a user disambiguation module 156, a recommendation engine 158, and a website generation engine 160. These modules may be implemented as software components executing on one or more servers, cloud computing platforms, or distributed computing systems.

Input interface module 152 provides user interfaces for receiving commodity identifiers and optional user profile information from computing device 110. In certain embodiments, input interface module 152 presents a web-based interface prompting the user to enter at least one commodity identifier. For book-related commodities, the commodity identifier may comprise an ISBN, EAN, book title, URL, or similar product identification code. Input interface module 152 may also prompt the user to provide optional social media profile information, such as an Instagram handle, Facebook profile identifier, Twitter handle, or other social media identifiers. The social media information is optional and may be omitted if the user prefers not to connect social media accounts or lacks social media presence. When social media information is not provided, the system may prompt the user to upload biographical information or images directly, or may retrieve user information from alternative sources.

Data aggregation module 154 receives the commodity identifier and optional social media information from input interface module 152 and queries multiple data sources 170 to retrieve relevant information. Data sources 170 may include proprietary databases containing commodity metadata, public databases or application programming interfaces (APIs) providing product information, social media platforms, review aggregators, and other digital sources. For example, when the commodity identifier is an ISBN, data aggregation module 154 may query book databases to retrieve information including but not limited to: book title, author name, publication date, publisher, genre, synopsis, cover image, page count, published reviews, and format. Data aggregation module 154 may query multiple data sources 170 simultaneously or in parallel to optimize retrieval speed.

In certain embodiments, data aggregation module 154 queries social media platforms using the provided social media identifier to retrieve user profile information, biographical text, profile images, follower counts, and recent posts. When multiple commodity identifiers are provided (for example, ISBNs for multiple books by the same author), data aggregation module 154 retrieves information for each commodity and aggregates the results.

Data aggregation module 154 may implement error handling and validation to address incomplete or conflicting information from different data sources 170. For example, if different databases provide inconsistent publication dates for the same book, data aggregation module 154 may apply rules to determine which source to prioritize, or may flag the discrepancy for user review. In certain embodiments, data aggregation module 154 includes caching mechanisms to store frequently accessed information and reduce query times for subsequent requests.

User disambiguation module 156 analyzes the retrieved commodity information to determine whether multiple commodities are associated with the same user or creator. This functionality is particularly relevant for authors, musicians, or other creators who may have produced multiple works. For example, when a user provides an ISBN for one book, user disambiguation module 156 may identify additional books by the same author based on author name matching, publisher information, genre similarity, or other correlating factors.

In certain embodiments, user disambiguation module 156 employs machine learning models or algorithms to determine whether commodities with similar creator names correspond to the same individual. This addresses scenarios where multiple creators share similar or identical names. User disambiguation module 156 may analyze patterns including writing style indicators, publication history, publisher relationships, genre consistency, geographic information, or other distinguishing characteristics to determine whether commodities should be grouped together under a single user identity. When user disambiguation module 156 identifies additional commodities belonging to the same creator, data aggregation module 154 may retrieve information for these additional commodities to provide comprehensive coverage in the generated website.

User disambiguation presents a significant technical challenge because commodities, particularly books, often involve creators with identical or similar names. Determining whether two commodities were created by the same individual requires analyzing multiple data points and resolving potential conflicts between data sources. The user disambiguation module 156 addresses this challenge through multi-factor analysis of commodity metadata.

For book-related commodities, user disambiguation module 156 analyzes genre information associated with books having the same or similar author names. Books by the same author typically exhibit genre consistency or patterns. For example, if an author named “John Smith” has published multiple thriller novels, a newly discovered book by “John Smith” in the thriller genre is more likely to belong to the same author than a children's book by “John Smith.” The disambiguation module examines genre classifications retrieved from data sources 170, calculating similarity scores based on genre overlap. Books sharing multiple genre tags or belonging to closely related genres receive higher confidence scores for common authorship.

Publication timing analysis provides additional disambiguation signals. User disambiguation module 156 examines publication dates for books by authors with similar names to identify temporal patterns. An author actively publishing books in the 2010s is unlikely to be the same person as an author who published exclusively in the 1950s. The module analyzes publication timelines, calculating temporal clustering to determine whether books fall within plausible career spans for a single author. Gaps in publication history, publishing frequency patterns, and career trajectory analysis inform the disambiguation determination. For example, an established author might publish books annually over decades, while a newer author might show recent concentrated publishing activity. These temporal patterns help distinguish between authors sharing similar names.

Publisher relationships provide strong disambiguation signals. User disambiguation module 156 analyzes which publishers have released books by authors with similar names. Authors typically maintain relationships with specific publishers or imprints, particularly within the traditional publishing industry. Books by “Jane Doe” published by Publisher A are more likely to share authorship with other “Jane Doe” books from Publisher A than with books from Publisher B, absent other connecting factors. The module examines publisher consistency across an author's catalog, with weight given to books from the same publisher or publishing house family. Self-published works may exhibit different patterns, where authors use multiple platforms or services, but even self-publishing shows patterns such as consistent use of specific ISBN registration agencies or distribution channels.

The user disambiguation module 156 implements a weighted scoring system that combines genre similarity, publication timing, and publisher relationships to generate confidence scores for commodity groupings. Each factor contributes to an overall disambiguation score, with configurable weight parameters. In certain embodiments, the system applies machine learning models trained on known author datasets to optimize weighting and identify additional subtle patterns indicative of common authorship. When confidence scores exceed threshold values, the module groups commodities under a single user identity. When scores fall into uncertain ranges, the system may flag potential matches for user review or maintain separate commodity groupings until additional confirming data becomes available.

Beyond these primary factors, user disambiguation module 156 may consider supplementary indicators including geographic information when available (authors often show regional publishing patterns or settings), biographical consistency across book jacket information or author profiles, writing style analysis when book content is accessible, subject matter expertise patterns, and dedication or acknowledgment patterns. These supplementary factors provide additional confirmation when primary factors yield ambiguous results. The multi-factor approach enables robust disambiguation even when individual data points provide contradictory signals, as the aggregate analysis produces reliable determinations across diverse scenarios.

Recommendation engine 158 analyzes the aggregated commodity information to recommend themes, layouts, color schemes, and other design elements for the website. The recommendations may be based on factors including commodity type, genre, quantity of commodities, availability of images, target audience characteristics, or other relevant attributes. For example, for an author with multiple books in the thriller genre, recommendation engine 158 may recommend darker color schemes and layouts emphasizing dramatic cover art. For an author with a single cookbook, recommendation engine 158 may recommend layouts emphasizing food photography and recipe previews.

In certain embodiments, recommendation engine 158 applies rule-based logic, machine learning models, or combinations thereof to generate recommendations. The recommendation engine 158 may maintain databases of theme-to-genre mappings, analyze successful website designs for similar commodities, or incorporate user preferences indicated during prior interactions. Recommendation engine 158 may generate multiple alternative recommendations ranked by suitability, allowing the user to select among recommended options or override recommendations with custom choices.

Recommendation engine 158 can also analyze the user's writing style from social media content, published works, or other available written materials. The recommendation engine 158 may employ natural language processing or machine learning models to identify the user's characteristic tone, vocabulary patterns, sentence structure preferences, and communication style. This stylistic analysis informs content generation for website components, enabling the system to draft biographical information, commodity descriptions, and other textual elements that authentically reflect how the user naturally communicates.

Website generation engine 160 receives the aggregated data from data aggregation module 154 and recommendation information from recommendation engine 158 to automatically construct a complete, functional website. Website generation engine 160 applies the selected or recommended theme, populates content sections with the retrieved information, configures navigation structures, establishes page hierarchies, and integrates functional elements such as purchase links, contact forms, and social media connections.

Website generation engine 160 can employ artificial intelligence (AI)-based content generation capabilities to draft website text components based on analyzed user writing style. When generating biographical sections, commodity descriptions, or other textual website elements, the engine applies the identified linguistic patterns from the user's social media posts or published works to create content that sounds authentically like the user wrote it. This AI-generated content distinguishes the system from platforms that populate websites with generic template text, providing personalized starting points that users may accept as-is, refine, or replace according to their preferences.

In certain embodiments, website generation engine 160 generates websites using modern web technologies including but not limited to HTML, CSS, JavaScript, and responsive design frameworks that adapt to various screen sizes and devices. Website generation engine 160 may utilize content management systems, static site generators, or custom rendering engines to produce the website output. The generated website is fully functional upon creation, requiring no additional coding or technical configuration by the user. Users may subsequently access editing interfaces to customize or modify the automatically generated content, as described in connection with subsequent figures.

Automatically generating a website can comprise the system programmatically creating a functional, publicly deployable website containing substantive content without requiring the user to manually enter, upload, or configure the majority of website content elements. Automatically generating the website can encompass the following automated operations performed by the system without manual user input for each operation. First, the system performs automated content retrieval by querying data sources and receiving book-related information, author biographical information, reviews, images, and other content without requiring the user to manually upload each element. Second, the system performs automated template selection by selecting a website template from a plurality of available templates based on algorithmic analysis of book characteristics without requiring manual template browsing or selection. Third, the system performs automated content population by programmatically populating website sections such as author biography, book descriptions, images, reviews, and purchase links with retrieved data without requiring manual copy-paste or field-by-field data entry. Fourth, the system performs automated structural configuration by generating navigation elements, page hierarchies, and layout arrangements without requiring manual drag-and-drop interface manipulation or code editing. Fifth, the system performs automated deployment preparation by generating HTML, CSS, JavaScript, and responsive design code sufficient to render the website on various devices without requiring manual coding.

Automatically generating permits limited user inputs that do not constitute manual content entry. These permitted inputs include providing commodity identifiers such as ISBN, optionally providing social media profile identifiers, selecting among automatically generated theme recommendations, accepting or modifying automatically populated configuration defaults, and post-generation editing through provided editing interfaces. The key distinction is that the system generates substantive website content from external data sources rather than requiring manual entry of that content by the user.

Website generation system 150 provides the generated website to computing device 110 via network 130, where the user can preview the website, make optional modifications, and publish the website to a chosen domain. In certain embodiments, the entire process from commodity identifier input to complete website generation occurs within seconds, enabling rapid deployment compared to conventional manual website building approaches.

While embodiments described herein focus on author websites generated from book identifiers, the principles extend to other commodities and users, including musicians with album identifiers, artists with work identifiers, merchants with product identifiers, and other creators or sellers whose commodities are associated with standardized identification codes that enable automated information retrieval from digital sources.

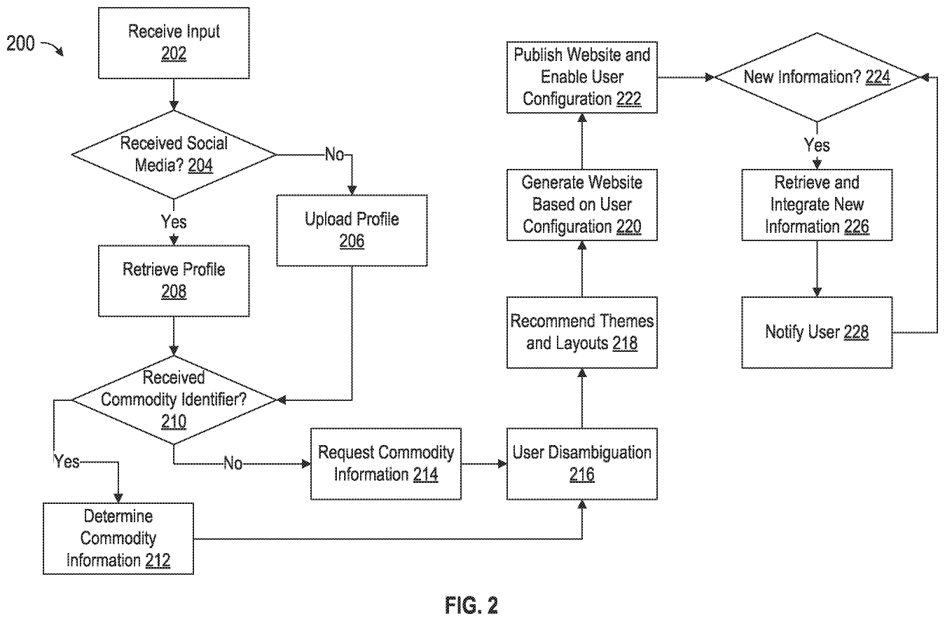

FIG. 2 illustrates a flowchart 200 depicting a process for automated website generation based on commodity identifiers and optional user profile information. The process may be implemented by website generation system 150 described in connection with FIG. 1, executing on one or more computing systems.

The process begins at stage 202, where the system causes a user interface to be displayed on a user's computing device, prompting the user to provide at least one commodity identifier. The user interface may be presented through a web browser, mobile application, or other client interface. In certain embodiments, the user interface includes input fields specifically configured to receive commodity identifiers such as ISBNs, EANs, Universal Product Codes (UPCs), book titles, URLs, or other standardized product identification codes. The interface may include validation to ensure the entered identifier conforms to expected formats, such as verifying ISBN check digits or proper code length. The system receives the commodity identifier input from the user. The user may enter a single commodity identifier or multiple commodity identifiers. For example, an author may provide ISBNs for several published books, or a merchant may provide product codes for multiple items. The system stores the received identifier(s) for subsequent processing.

At decision point 204, the system determines whether social media profile information was received from the user. The user interface at stage 202 may include optional fields for social media identifiers such as Instagram handles, Facebook profile names, Twitter usernames, or other social platform identifiers. If the user provided social media information (YES branch), the process proceeds to stage 208. If the user did not provide social media information (NO branch), the process proceeds to stage 206.

At stage 206, the system prompts the user to upload user profile information directly. This step provides an alternative pathway for users who do not wish to connect social media accounts or lack social media presence. The system may prompt the user to provide information including but not limited to user name, biographical text, profile images, contact information, or other relevant details. This information gathering is optional, and users may skip this step if they prefer the system to proceed with commodity information alone. The manually provided user information is stored for incorporation into the generated website. In other embodiments, the system may attempt to retrieve the user profile information from other data sources when social media information is not provided.

At stage 208, reached when social media information was provided at decision point 204, the system automatically retrieves user profile data from the identified social media platform. The system queries social media platforms using the provided social media identifier to retrieve user profile data including biographical text, profile images, posts, follower counts and information, linked accounts, and other publicly available profile information. Social media APIs may be used to access this information in structured formats. The automatically retrieved social media data is aggregated for subsequent incorporation into the generated website.

Both stage 206 and stage 208 proceed to decision point 210, where the system determines whether a commodity identifier was received at stage 202. If at least one commodity identifier was received (YES branch), the process proceeds to stage 212. If no commodity identifier was received (NO branch), the process proceeds to stage 214.

At stage 212, the system retrieves commodity information using the received commodity identifier(s). The system initiates queries to multiple data sources using the received commodity identifier(s). The data sources may include proprietary databases containing commodity metadata, public APIs providing product information, publisher databases, retail platforms, review aggregators, and other sources of commodity-related information. The queries may be executed in parallel to optimize retrieval speed. For book-related commodities, the system may query databases to retrieve information including but not limited to book titles, author names, publication dates, publishers, genres, synopses, cover images, page counts, formats, ISBNs for related editions, and published reviews. The retrieved information is aggregated and organized for subsequent processing. In certain embodiments, the system validates the retrieved information, checks for completeness, and resolves conflicts when different data sources provide inconsistent information. After completing commodity information retrieval, the process proceeds to stage 216.

In certain embodiments, the system analyzes the user's existing social media content and other available written materials to learn the user's authentic writing style, including voice characteristics. The system employs machine learning models, natural language processing algorithms, or AI-based text generation capabilities to identify linguistic patterns within a corpus of the user's social media posts and other relevant information such as books, articles, and other publications authored by the user. The style analysis examines common phrases or expressions the user employs, sentence length and complexity preferences, formality level ranging from casual conversational tone to professional business tone, use of humor, enthusiasm, or other emotional characteristics, first-person versus third-person perspective preferences, and characteristic vocabulary choices that distinguish the user's voice. The system may also analyze content from the user's books or other commodities to extract thematic elements, key messaging points, subject matter expertise, and narrative patterns that can inform generated website content. This stylistic and content analysis enables the system to generate website components that authentically sound like the user wrote them, rather than relying on generic, formulaic website content.

At stage 214, reached when no commodity identifier was received at decision point 210, the system requests commodity information from the user through alternative means. This step ensures that users can generate websites even without standardized commodity identifiers. The system may prompt the user to provide information such as website links for existing commodity pages, commodity names or titles, descriptions, images, or other identifying information sufficient to enable the system to search data sources 170 for relevant information. For example, a user might provide a link to a book's Amazon page, the book title and author name, or similar information that allows the system to locate and retrieve commodity data. The system uses the manually provided information to query data sources and retrieve available commodity information. After retrieving commodity information based on user-provided details, the process proceeds to stage 216.

At stage 216, reached from both stage 212 and stage 214, the system performs user disambiguation to determine whether multiple commodities should be associated with the same user or creator. This stage implements the functionality of user disambiguation module 156 described in connection with FIG. 1. User disambiguation addresses the common challenge that multiple creators may share similar or identical names, requiring analysis to determine whether commodities should be grouped together or maintained as separate entities.

The disambiguation process analyzes the commodity information retrieved at stage 212 or stage 214, examining patterns and characteristics that indicate common authorship or ownership. For book-related commodities, the system performs genre-based disambiguation analysis. When books with the same or similar author names are identified in the data sources, the system compares their genre classifications. Books by the same author typically exhibit genre consistency, clustering within related genres or demonstrating consistent genre patterns over a publishing career. The system calculates genre similarity scores based on overlap in genre tags, subject classifications, and categorical assignments. Books sharing thriller, mystery, and suspense classifications are more likely to share authorship than books spanning unrelated genres like children's picture books and academic textbooks. Genre analysis provides a strong signal for disambiguation, particularly for fiction authors who typically specialize within specific genres.

The system performs publication timing analysis to identify temporal patterns in an author's publishing history. Publication dates for books by authors with similar names are examined to determine whether the timing suggests a single author career or multiple distinct authors. The system analyzes several temporal factors including whether publication dates fall within a plausible career span for a single individual (typically measured in decades), whether publication frequency follows consistent patterns (such as annual releases, biennial publications, or clustered publication periods), whether significant gaps exist that might indicate different authors or distinct career phases, and whether publication timelines show logical progression from early works through recent releases. For example, books by “Michael Johnson” published in 1975, 1978, 1982, 1985, 1990, 1995, 2001, 2005, 2010, 2015, and 2020 demonstrate a consistent publishing career spanning decades, suggesting a single author. In contrast, books by “Michael Johnson” from 1965, 1968, and 1970, alongside separate books by “Michael Johnson” from 2015, 2018, and 2021, more likely represent different authors given the temporal gap and distinct career periods.

Publisher relationship analysis examines which publishers have released books by authors sharing similar names. Authors typically develop relationships with specific publishers or publishing imprints, particularly in traditional publishing. The system analyzes publisher consistency across books, assigning higher confidence to common authorship when books share publishers or come from related imprints within the same publishing house. For example, if five books by “Sarah Williams” were all published by Publisher X or its imprints, while three books by “Sarah Williams” were published by Publisher Y, the system recognizes two distinct probable author identities. Publisher analysis accommodates the realities of modern publishing, including that authors may change publishers between books, self-published authors may use multiple platforms, and authors may work with different publishers for different genres or markets. The analysis weighs publisher relationships as one factor among several rather than requiring absolute publisher consistency.

The system combines these factors using a weighted scoring algorithm to generate overall confidence scores for commodity groupings. Each factor (e.g., genre similarity, publication timing, and publisher relationships) contributes to the aggregate score with configurable weights. In certain embodiments, genre similarity might be weighted at 40%, publication timing at 30%, and publisher relationships at 30%, though weights may be adjusted based on commodity type or empirical performance. The system calculates confidence scores indicating the probability that commodities share common authorship. When confidence scores exceed predetermined thresholds (such as 80% or 85%), the system automatically groups commodities under a single user identity. When scores fall below lower thresholds (such as 40% or 30%), the system maintains separate commodity identities. When scores fall in intermediate ranges, the system may flag the ambiguity for subsequent review or may maintain separate groupings pending additional confirming data.

In certain embodiments, user disambiguation module 156 implements machine learning models trained on datasets of known authors and their works to optimize the disambiguation process. Training data comprises verified author identities with their complete bibliographies, allowing the system to learn subtle patterns indicative of common authorship beyond the primary factors. Machine learning models may identify additional correlating factors such as characteristic writing style indicators when book content is accessible, biographical information consistency across author profiles, geographic patterns in publication or book settings, subject matter expertise patterns suggesting specialized knowledge, dedication or acknowledgment patterns that recur across an author's works, and cover design or series branding patterns that authors maintain across books. The machine learning approach enables continuous improvement as the system encounters additional data and user corrections.

When user disambiguation identifies additional commodities belonging to the same user that were not initially provided by the user, the system automatically initiates retrieval of information for these additional commodities. The data aggregation module 154 queries data sources 170 to obtain comprehensive information for the newly identified books or commodities, including titles, descriptions, images, publication dates, reviews, and all other metadata described in connection with stage 212. This automatic expansion of the commodity set ensures that generated websites provide complete coverage of a user's work without requiring the user to manually identify and enter information for each commodity individually. For example, when a user provides a single ISBN for one book, effective disambiguation and automatic retrieval might result in a complete website featuring the author's entire catalog of ten or fifteen books, dramatically reducing manual effort.

The disambiguation process accommodates scenarios where initial disambiguation may be uncertain or require refinement. In certain embodiments, the system may present disambiguation results to users for confirmation, displaying groups of potentially related commodities and allowing users to confirm groupings, split incorrectly grouped commodities, or merge commodities that were incorrectly separated. User feedback is incorporated into the disambiguation model, improving future disambiguation performance through reinforcement learning or updated rule parameters. In other embodiments, particularly where confidence scores are high, the system proceeds automatically without user confirmation, expediting website generation while maintaining accuracy through robust multi-factor analysis. After completing user disambiguation and retrieving information for any additional identified commodities, the process proceeds to stage 218.

At stage 218, the system analyzes the aggregated commodity information and user profile data to generate theme and layout recommendations. The analysis considers factors including commodity genre or category, quantity of commodities, availability of high-quality images, presence of published reviews, target audience characteristics, and other relevant attributes. The system applies recommendation logic to identify themes, color schemes, layouts, and design elements suited to the specific characteristics of the commodity set and user profile. In certain embodiments, the system generates multiple alternative recommendations ranked by suitability scores. The user can configure the website to be generated using the recommendations and tools provided by the system.

At stage 220, the system automatically generates a complete, functional custom website using the aggregated commodity information, user profile data, recommended design elements, and user configuration. The website generation process includes populating content sections with retrieved information, applying the selected theme, configuring page structures and navigation, establishing commodity display pages (such as individual book pages or product pages), integrating purchase links, embedding social media connections, and configuring functional elements such as contact forms or newsletter signups. The generated website is fully functional and requires no additional coding or technical configuration by the user.

The website generation process at stage 220 can leverage the style analysis performed at stage 208 to automatically draft website content components that mimic the tone and writing characteristics of the user. The system employs the identified linguistic patterns to generate biographical text, commodity descriptions, and other textual website elements written in the user's authentic voice. For example, the system may generate an author biography that reflects the user's characteristic formality level, sentence structure preferences, and vocabulary choices based on analysis of their social media posts and published works. Similarly, commodity descriptions may be drafted to match the user's established writing style while incorporating key information from retrieved commodity data. The AI-generated content maintains consistency with how the user naturally communicates, distinguishing the generated website from platforms that populate sites with generic, impersonal text. Users may subsequently edit, refine, or replace the automatically drafted content through the editing interfaces described in connection with subsequent figures, but the initial generation provides authentic, personalized starting points that significantly reduce manual content creation effort while preserving the user's unique voice and brand identity.

At stage 222, the system presents the generated website to the user through a preview interface. The user can view the complete website, navigate through its pages, and assess the automatically populated content and design. The preview interface may include options to modify, customize, or regenerate the website with different theme selections. The system also provides editing interfaces allowing the user to customize the generated website. The user may modify biographical information, adjust commodity descriptions, change themes or layouts, add or remove content sections, upload additional images, configure purchase links, configure review pages, or make other customizations. These editing capabilities are optional, and users may choose to publish the automatically generated website without modifications.

The system publishes the website to an automatically generated or user-specified domain or subdomain. Publishing may involve deploying the website to hosting infrastructure, configuring Domain Name System (DNS) settings, establishing Secure Sockets Layer (SSL) certificates for secure connections, and making the website publicly accessible. In certain embodiments, the system integrates with domain registration services to facilitate domain acquisition if the user does not already possess a suitable domain.

With the user's custom website deployed and accessible to visitors, the process can include monitoring capabilities to automatically update the published website with new information at decision point 224. The system may periodically query the data sources described in connection with stage 212 to identify new commodities associated with the user (such as newly published books by the same author), updated commodity information (such as new reviews, revised cover images, or updated pricing), changes to user social media profiles, or other relevant updates. If new information is identified (YES branch), the process proceeds to stage 226, where the new information is retrieved and automatically integrated into the website. In some embodiments, user approval is required before updating the website, allowing users to review proposed changes before they become publicly visible. If no new information is identified (NO branch), the system continues monitoring according to a predetermined schedule or triggering event.

At stage 228, the system notifies the user of the update (or recommended update if user approval is required) to the website. The system then continues monitoring according to a predetermined schedule or triggering event.

In certain embodiments, the entire process from initial commodity identifier input at stage 202 to complete website generation at stage 220 occurs within seconds, enabling rapid website deployment. The generated website may subsequently be updated or modified through the editing interfaces provided by the system. A processor executing instructions on a storage media comprises an example means for performing the process illustrated in FIG. 2.

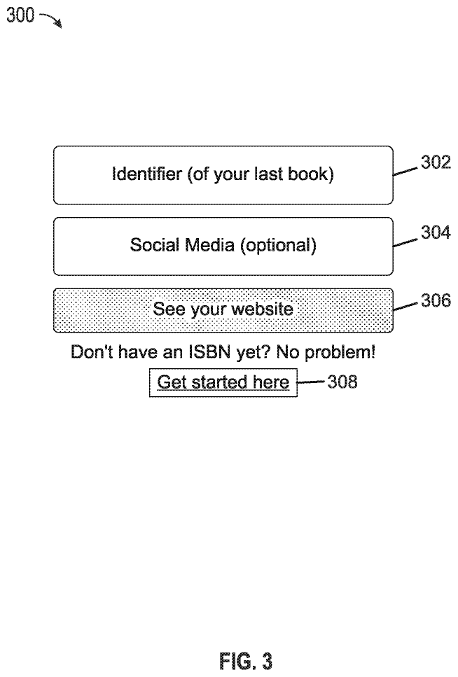

FIG. 3 illustrates a user interface 300 for receiving commodity identifier and optional social media information. This interface implements the initial data collection stage 202 described in connection with FIG. 2, providing users with input mechanisms to initiate the automated website generation process.

User interface 300 is presented on a user's computing device, such as computing device 110 described in connection with FIG. 1, through a web browser or dedicated application. The interface provides a streamlined entry point for users to begin website generation by providing minimal required information, from which the system automatically retrieves comprehensive data from multiple sources.

Identifier input field 302 allows the user to enter at least one commodity identifier. The identifier input field 302 is configured to accept various types of standardized product identification codes depending on the commodity type. For book-related commodities, identifier input field 302 accepts ISBNs in various formats including ISBN-10 and ISBN-13, as well as EANs, book titles, URLs, or other book identifiers. For other commodity types, the identifier input field 302 may accept UPCs, catalog numbers, model numbers, or other standardized identification codes that enable automated information retrieval from digital sources.

In certain embodiments, identifier input field 302 includes validation logic that verifies the format and validity of entered identifiers. For example, the system may verify ISBN check digits, confirm proper code length, or validate that the identifier conforms to expected patterns for the specified commodity type. The validation may occur in real-time as the user types, providing immediate feedback regarding identifier validity. Identifier input field 302 may accept multiple commodity identifiers, allowing users to enter ISBNs for multiple books or product codes for multiple items. The interface may provide mechanisms for adding additional identifier input fields or accepting comma-separated or line-separated lists of identifiers. Because the system performs user disambiguation to identify associated commodities, providing multiple identifiers is not required for the system to identify multiple commodities associated with the user.

In the illustrated embodiment showing an author website generation scenario, identifier input field 302 is labeled to prompt for book ISBNs, and may include example formatting or placeholder text demonstrating proper identifier entry (such as “978-0-123456-78-9” for ISBN-13 format). The interface may include helpful text explaining where users can locate ISBNs on their books, such as on the back cover or copyright page.

Social media input field 304 allows the user to optionally provide social media profile information. This field is optional, as indicated by interface labeling or visual cues, and users may leave this field blank if they do not wish to connect social media accounts or lack social media presence. Social media input field 304 may be configured to accept various social media identifiers including Instagram handles (with or without the “@” symbol), Facebook profile URLs or usernames, Twitter handles, LinkedIn profile URLs, TikTok usernames, or identifiers for other social media platforms.

In certain embodiments, social media input field 304 includes dropdown menus, radio buttons, or other selection mechanisms allowing users to specify which social media platform they are providing information for. The system uses the platform designation to query the appropriate social media APIs and retrieve relevant user profile data as described in connection with stage 208 of FIG. 2. The retrieved social media data may include biographical text, profile images, follower counts, recent posts, and other publicly available information that can be incorporated into the generated website.

When users provide social media information through social media input field 304, the system may automatically retrieve and populate user profile sections of the generated website, reducing or even eliminating the need for manual entry of biographical information and images. When users do not provide social media information, the system may subsequently prompt for manual upload of user profile information as described in connection with stage 206 of FIG. 2.

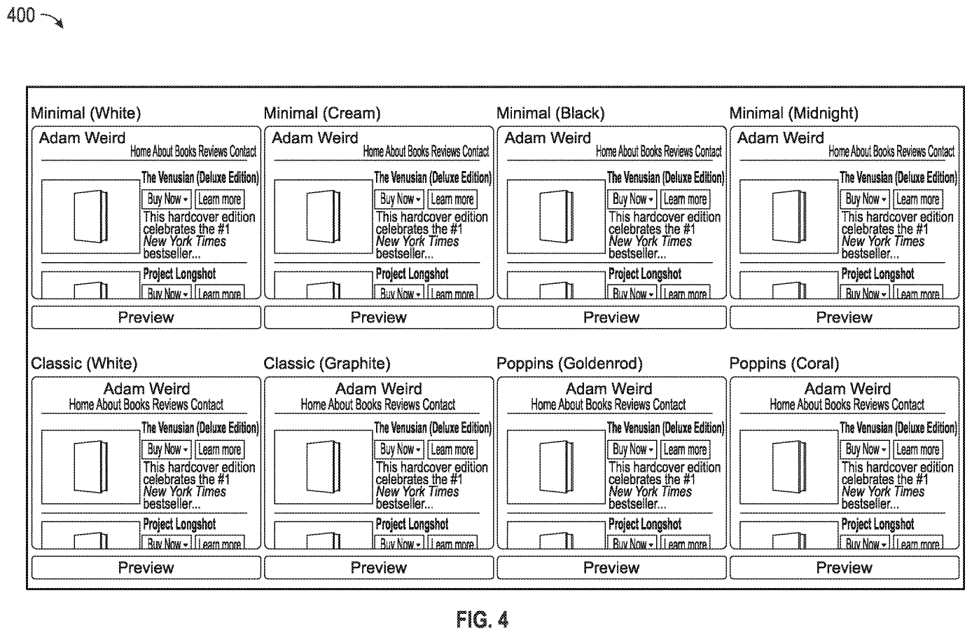

Proceed input element 306 comprises a button, link, or other interactive control that, when activated by the user, initiates the automated website generation process. In certain embodiments, activation of proceed input element 306 causes the system to validate the entered commodity identifier in identifier input field 302, retrieve commodity information from multiple data sources as described in connection with stage 212 of FIG. 2, and present theme and layout recommendation interfaces as illustrated in FIG. 4. The proceed input element 306 may be labeled with text such as “Continue,” “Next,” “Generate Website,” or similar language indicating forward progress in the website creation workflow.

Before proceeding, the system may verify that at least one valid commodity identifier has been entered in identifier input field 302. If no identifier or an invalid identifier is detected, the system may display error messages or validation feedback prompting the user to correct the input before proceeding.

Alternative input element 308 provides a pathway for users who do not have commodity identifiers available or prefer to proceed without using standardized identification codes. This element may comprise a button, link, or control labeled with text such as “I don't have an ISBN,” “Proceed without identifier,” “Manual entry,” or similar language indicating an alternative workflow. When activated, alternative input element 308 causes the system to present interfaces for manual commodity information entry as described in connection with stage 214 of FIG. 2.

The alternative input element 308 ensures that the system accommodates users across various scenarios, including authors whose books lack ISBNs (such as self-published works not registered with ISBN agencies), merchants selling custom or handmade products without standardized codes, or users who cannot readily locate their commodity identifiers. When this pathway is selected, the system may prompt users to provide alternative identifying information such as commodity names, descriptions, website links to existing product pages, or other details sufficient to enable information retrieval or manual population of website content.

User interface 300 may include additional elements not specifically numbered in FIG. 3, such as help text, tooltips, examples, progress indicators, branding elements, or navigation controls. The user interface 300 design prioritizes simplicity and minimal required user input, reflecting the system's capability to automatically generate comprehensive websites from limited initial information. By requiring only a commodity identifier and optional social media information, the user interface 300 enables rapid initiation of the website generation process, consistent with the rapid deployment objectives described throughout this disclosure.

FIG. 4 illustrates a theme and layout recommendation interface 400 with theme selection options for website customization. A theme and layout recommendation interface 400 can be presented after the user provides commodity identifier and optional social media information through user interface 300 of FIG. 3 and activates proceed input element 306. The theme and layout recommendation interface 400 implements the theme and layout recommendation functionality performed by recommendation engine 158 described in connection with FIG. 1 and stage 218 described in connection with FIG. 2.

The theme and layout recommendation interface 400 displays recommended themes and layouts automatically generated by the system based on analysis of the retrieved commodity information and user profile data. The recommendations are tailored to the specific characteristics of the user's commodities, including factors such as genre, quantity of commodities, availability of images, target audience, and other relevant attributes. By providing intelligent recommendations rather than requiring users to navigate through extensive catalogs of generic templates, the system accelerates the website generation process while ensuring aesthetic and functional alignment with the commodity type.

In certain embodiments, the theme and layout recommendation interface 400 presents multiple theme options for user selection. Each theme option comprises a coordinated combination of visual design elements including color palettes, typography selections, graphical styling, and aesthetic motifs. The color palettes define the primary, secondary, and accent colors used throughout the website, affecting background colors, text colors, button styling, header designs, and other visual elements. Typography selections specify font families, font sizes, font weights, and text styling applied to headings, body text, navigation elements, and other textual content.

The themes may incorporate design motifs or visual elements that complement the commodity genre or category. For example, for books in the science fiction genre, recommended themes may include space-inspired designs featuring cosmic imagery, futuristic typography, dark backgrounds with bright accent colors, and visual elements suggesting technology or exploration. For cookbooks or food-related commodities, recommended themes may feature warm color palettes, clean modern typography, imagery emphasizing food photography, and layouts optimized for recipe display. For thriller or mystery novels, themes may incorporate darker color schemes, dramatic typography, high-contrast designs, and atmospheric visual elements creating suspense or intrigue.

In certain embodiments, the system analyzes the retrieved book cover images or commodity images to extract dominant colors, which may inform the recommended color palettes. This ensures visual harmony between the commodity imagery and the overall website design. The system may also consider market research data, successful design patterns for similar commodities, or user preferences indicated in prior interactions when generating theme recommendations.

The theme and layout recommendation interface 400 also presents layout options that define the structural organization and content arrangement of the generated website. Layout options specify how commodity information, user biographical information, purchase links, reviews, and other content elements are positioned and displayed across website pages. Different layout configurations may emphasize different aspects of the content depending on the commodity characteristics and user objectives.

For example, a layout option for an author with a single published book may feature prominent display of the book cover on the homepage, with the book title and description occupying central visual space, author biographical information in a secondary position, and purchase links prominently accessible. In contrast, a layout option for an author with multiple published books may feature a grid or gallery display of book covers on the homepage, allowing visitors to browse the author's catalog, with individual book pages accessible through navigation. A layout optimized for authors with extensive social media presence may integrate social media feeds, follower counts, or recent posts into prominent homepage positions.

Layout options may also define functional elements including navigation menu structures (such as horizontal navigation bars, sidebar menus, or hamburger menus for mobile devices), footer content arrangement, contact form placement, newsletter signup positioning, and integration points for social media links or embedded content. The layouts are responsive, meaning they automatically adapt to different screen sizes and devices including desktop computers, tablets, and smartphones, ensuring optimal viewing experiences across platforms.

In the illustrated embodiment, each theme and layout option is presented with visual previews, thumbnails, or example renderings that demonstrate how the website will appear when that option is selected. These previews may show actual commodity data retrieved for the user's specific books or products, providing personalized visualization rather than generic placeholder content. Users can interact with the previews to see different pages or sections of the website as they would appear with each theme and layout combination.

The theme and layout recommendation interface 400 includes selection mechanisms such as radio buttons, clickable tiles, or other interactive controls allowing users to choose their preferred theme and layout combination. In certain embodiments, the system ranks the recommendations by suitability scores, with the highest-ranked recommendation presented as a default or suggested selection. Users may accept the recommended selection or override it by choosing alternative options.

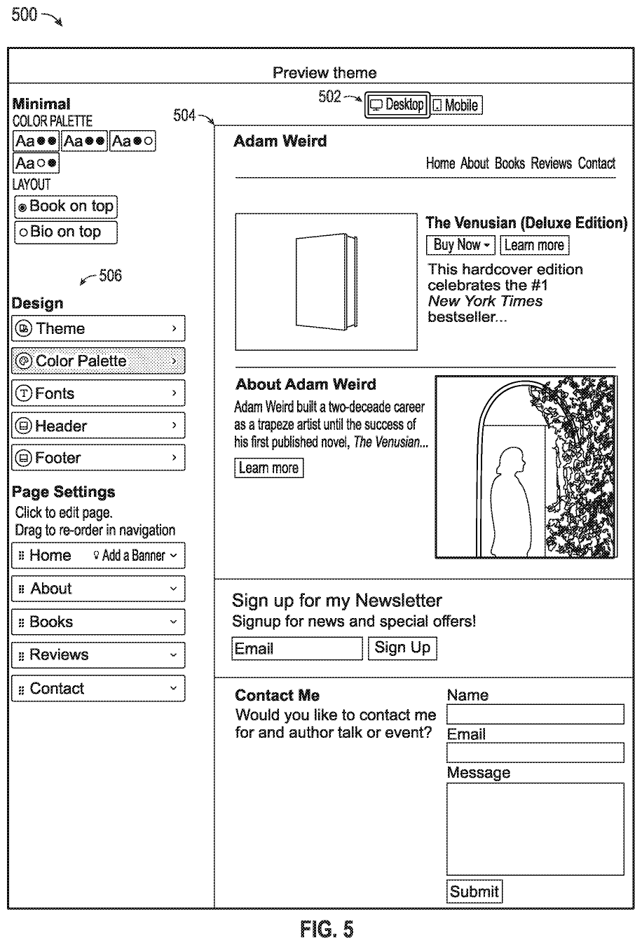

After selecting theme and layout preferences, users may proceed to additional configuration interfaces as illustrated in FIG. 5, where further customization options are presented before final website generation. Alternatively, in certain embodiments, users may proceed directly to website generation based solely on the theme and layout selections made in this theme and layout recommendation interface 400, with the system automatically generating the complete website using the selected design parameters and retrieved content.

The theme and layout recommendation interface 400 streamlines the design decision process by presenting a curated set of professionally designed options specifically tailored to the user's commodities, rather than overwhelming users with extensive catalogs of generic templates requiring manual evaluation and comparison. This approach reduces the time and expertise required for website design while ensuring aesthetic quality and functional appropriateness for the specific commodity type and user profile.

FIG. 5 illustrates an example of a configuration interface 500 for configuring website design options prior to website generation. This configuration interface 500 is presented after the user selects theme and layout preferences through the theme and layout recommendation interface 400 illustrated in FIG. 4, and provides additional configuration capabilities allowing users to personalize the website before final generation. The configuration interface 500 can include device preview controls 502, a website preview 504, and interface controls 506. The interface implements the user configuration functionality described in connection with stage 218 of FIG. 2, where users can configure the website using recommendations and tools provided by the system.

The configuration interface 500 provides granular control over design elements, content organization, and functional features while maintaining accessibility for users without technical expertise. The system populates the configuration interface 500 with intelligent defaults based on the theme and layout selections made in FIG. 4 and the commodity information retrieved from data sources, allowing users to accept these defaults or make personalized adjustments according to their preferences.

In certain embodiments, the configuration interface 500 includes device preview controls 502 that allow users to view how the website will appear on different device types, including desktop computers and mobile devices such as smartphones or tablets. Users may toggle between desktop view and mobile view through selectable tabs, buttons, or viewport size controls. The preview dynamically updates to show the responsive design adaptation for each device type, demonstrating how content reflows, navigation adjusts, images scale, and layout elements reposition to optimize the viewing experience for different screen sizes.

The device preview controls 502 enable users to make configuration changes that apply uniformly to both desktop and mobile views, or to make individual adjustments specific to each device type. For example, a user might adjust a color palette setting with the change automatically applied to both desktop and mobile versions, ensuring consistent branding across devices. Alternatively, a user might configure certain layout elements to appear differently on mobile devices than on desktop, such as adjusting header sizing, modifying navigation menu styles (converting desktop horizontal navigation to mobile hamburger menus), or changing image display configurations to optimize for smaller screens. The system maintains the responsive design integrity while allowing device-specific customization where appropriate.

In certain embodiments, the interface controls 506 includes theme adjustment controls that allow users to modify visual design elements of the selected theme. Users may change the theme entirely by selecting a different theme option from those presented in FIG. 4 or from an expanded theme catalog. The configuration interface 500 may provide controls for adjusting the color palette, allowing users to modify primary colors, secondary colors, accent colors, background colors, or text colors. Color selection may be facilitated through color picker tools, predefined color scheme options, or input fields accepting hexadecimal color codes.

Typography controls allow users to adjust font selections for different text elements throughout the website. Users may select font families for headings, body text, navigation menus, and other textual elements from libraries of web-safe fonts or web font services. The configuration interface 500 may provide website preview 504 functionality showing how different font combinations appear with the user's actual content, enabling informed typography decisions.

Header and footer customization controls allow users to configure the appearance and content of these persistent website elements. Header configuration may include options for logo placement, site title display, navigation menu styling, color schemes, and layout arrangements. Users may upload custom logo images or select from automatically generated logo options based on the user's name or brand. Footer configuration may include options for footer content sections, social media icon placement, contact information display, copyright text, and footer color schemes.

Layout element adjustment controls allow users to modify the structural organization of content within the selected layout. Users may adjust the positioning, sizing, or visibility of various content elements including commodity images, commodity descriptions, user biographical sections, purchase links, review displays, social media feeds, and other components. In certain embodiments, the configuration interface 500 provides drag-and-drop functionality allowing users to reposition elements visually, or provides toggle switches, sliders, or dropdown menus for adjusting element properties. The layout adjustments are applied within the framework of the selected layout option, maintaining responsive design integrity while allowing personalization.

Page configuration controls allow users to determine which pages are included in the generated website and to specify the order in which pages appear in navigation menus. Standard page options may include a home page, an about page (featuring user biographical information), commodity pages (displaying individual commodities or commodity catalogs), review pages (featuring published reviews or testimonials), contact pages (providing contact forms or contact information), and other page types relevant to the commodity and user. Users may select which pages to include by activating checkboxes, toggle switches, or similar selection mechanisms for each page type.

The configuration interface 500 provides page ordering functionality allowing users to specify the sequence in which pages appear in website navigation. In certain embodiments, users may drag pages into desired positions within a visual list, use up/down arrows to adjust page positions, or assign numerical order values. For example, a user might configure page order as: home page, about user page, commodity page, review page, contact page, ensuring that navigation menus present links in this specified sequence. The system applies the user-specified page order when generating the website navigation structure.

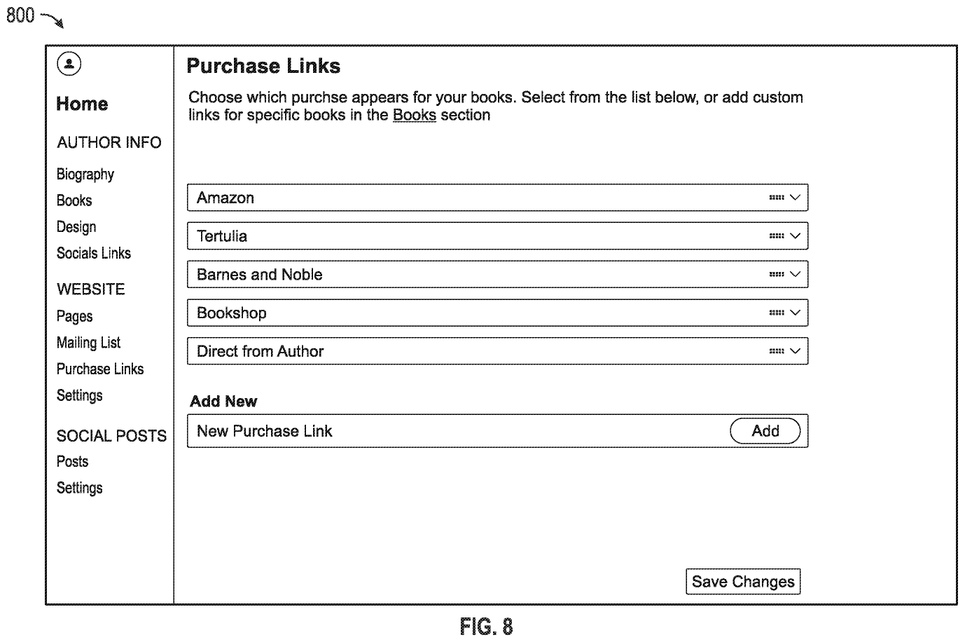

Purchase link configuration controls allow users to specify where visitors can purchase the displayed commodities. The configuration interface 500 may present options for various retail platforms, online bookstores, e-commerce services, or custom links. For books, purchase link options may include major retailers such as Amazon, Barnes & Noble, independent bookstores, or direct purchase options. Users may select one or multiple purchase link destinations, and the system configures the generated website to display purchase buttons or links directing visitors to the specified destinations. In certain embodiments, the system automatically retrieves purchase links for the user's commodities from retail platforms using the commodity identifiers, and presents these automatically populated links for user verification or modification. More detailed purchase link configuration may be accessed through dedicated interfaces as illustrated in FIG. 8.

Contact form setup controls allow users to configure contact functionality for the website. Users may enable or disable contact forms, specify which fields are included in contact forms (such as name, email, phone number, message), designate email addresses where contact form submissions should be delivered, and configure automated response messages sent to visitors upon form submission. The configuration interface 500 may also provide options for alternative contact methods such as displaying email addresses directly, providing phone numbers, or linking to social media messaging.

Domain selection controls allow users to specify the domain or subdomain where the generated website will be published. In certain embodiments, the system automatically generates a subdomain based on the user's name, book title, or other identifying information, and presents this automatically generated domain as a default option. For example, for an author named Jane Smith, the system might automatically generate a subdomain such as “janesmith.tertulia.com” or similar. Users may accept the automatically generated domain or specify a custom domain they own or wish to register.

The configuration interface 500 may integrate with domain registration services, allowing users to search for domain availability, register new domains, or connect existing domains they control. When users select custom domains, the configuration interface 500 may provide instructions or automated configuration for pointing the domain to the website hosting infrastructure, including DNS configuration guidance or automated DNS record updates.

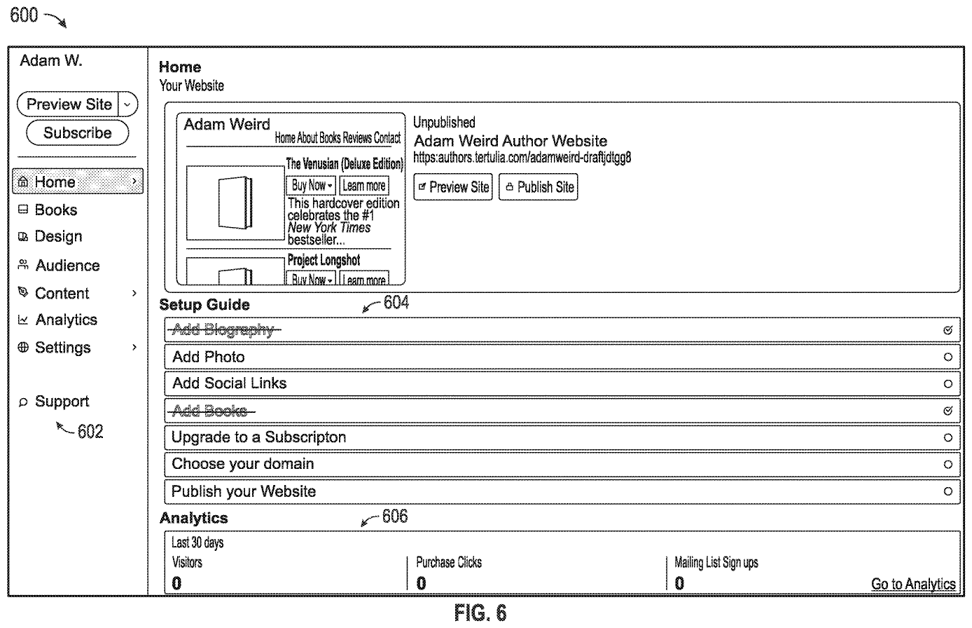

After completing configuration adjustments, users may proceed to website generation by activating a generation control such as a “Generate Website” button. Upon activation, the system uses the aggregated commodity information, user profile data, selected theme and layout, and user-specified configuration parameters to automatically generate the complete, functional website as described in connection with stage 220 of FIG. 2. The generated website is then presented through the interface illustrated in FIG. 6.

The configuration interface 500 balances automation with customization, providing users with meaningful control over their website's appearance and functionality while maintaining the rapid deployment advantages of automated generation. Users who prefer to minimize configuration time may accept the intelligent defaults populated by the system, while users desiring greater personalization may adjust numerous parameters to achieve their specific vision. This flexible approach accommodates diverse user preferences and technical comfort levels while ensuring all users can successfully generate professional, functional websites.

FIG. 6 illustrates an example of a website preview and management interface 600 displaying a generated website with configuration and publishing options. This website preview and management interface 600 is presented after the system automatically generates the website as described in connection with stage 220 of FIG. 2, and implements the preview and editing functionality described in connection with stage 222 of FIG. 2. The website preview and management interface 600 provides comprehensive website management capabilities, allowing users to view, edit, and publish their generated websites, as well as access analytics and ongoing customization tools.

Website preview and management interface 600 displays the generated website as it will appear to visitors when published. The preview shows the actual website with all automatically populated content, including commodity information, user biographical data, images, purchase links, reviews, and other elements retrieved and aggregated from data sources as described in connection with FIG. 1 and FIG. 2. The preview is fully interactive, allowing users to navigate between pages, click links, view different sections, and experience the website functionality as visitors would.

In certain embodiments, website preview and management interface 600 includes viewport controls allowing users to toggle between desktop and mobile views, similar to the device preview functionality described in connection with FIG. 5. This enables users to verify that the responsive design displays properly across different device types and screen sizes.

The website preview and management interface 600 is accessible both before initial publication and after publication, enabling customization at any point in the website lifecycle. Users may make edits to their websites immediately after generation and before publishing, or may return to the interface at any time after publication to make ongoing modifications. This persistent editing capability allows websites to evolve as users add new commodities, update biographical information, refine design elements, or adjust content based on visitor analytics and feedback.

Editing controls 602 provide access to comprehensive customization and configuration options for the generated website. These controls may be organized as navigation menus, tabbed interfaces, icon-based toolbars, or hierarchical panels providing structured access to different categories of editing functionality. The editing controls 602 enable users to modify various aspects of the website without requiring coding knowledge or technical expertise.

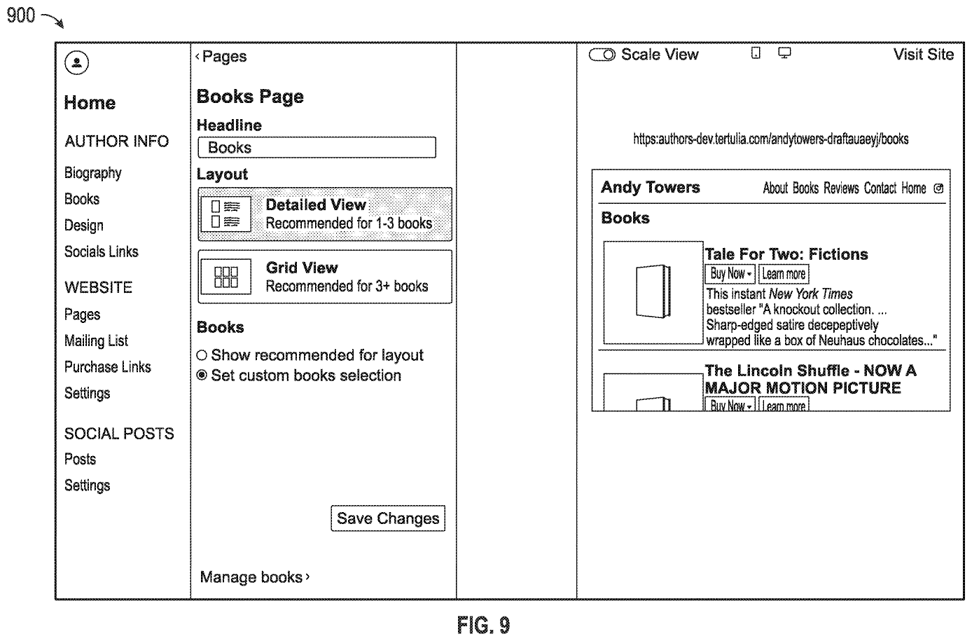

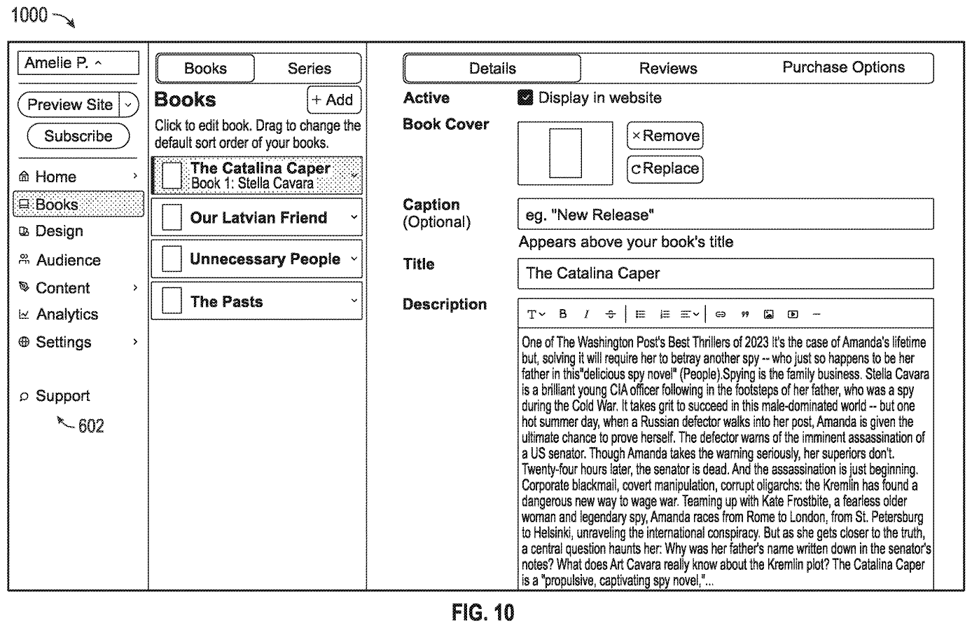

Commodity configuration controls within editing controls 602 allow users to add, remove, or modify commodity listings on the website. Users may add new commodities by providing additional commodity identifiers (triggering the data retrieval process described in connection with stage 212 of FIG. 2), manually entering commodity information, or uploading commodity data. Users may edit existing commodity entries to adjust titles, descriptions, images, pricing information, purchase links, or other commodity-specific details. For websites featuring multiple commodities, users may reorder how commodities are displayed, feature specific commodities prominently, or organize commodities into categories or collections. Detailed commodity configuration interfaces are illustrated in connection with FIG. 9 and FIG. 10.

Design configuration controls within editing controls 602 provide access to the theme, layout, and visual design adjustments described in connection with FIG. 5. Users may change themes entirely, adjust color palettes, modify typography, customize headers and footers, reposition layout elements, or make other visual design modifications. The design configuration maintains responsive design integrity while allowing personalized styling.

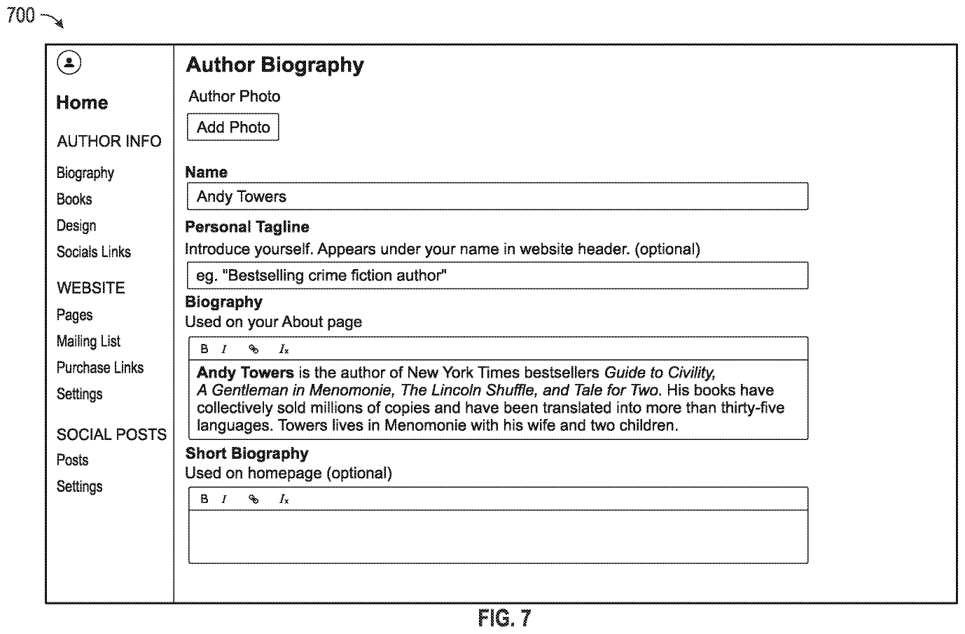

Content configuration controls within editing controls 602 allow users to modify various content sections of the website. User information configuration enables editing of biographical text, profile images, contact details, and other personal or business information. This functionality is illustrated in greater detail in connection with FIG. 7. Social media configuration allows users to add, remove, or modify connected social media accounts, adjust social media feed displays, or update social media links. Blog configuration, when applicable, enables users to create, edit, or delete blog posts, configure blog layouts, manage post categories or tags, and control comment settings. Additional content configuration may include newsletter signup forms, testimonial sections, press coverage, event calendars, or other content types relevant to the user's objectives.

Email marketing configuration controls within editing controls 602 provide comprehensive email campaign management capabilities, enabling users to build and engage their audiences directly through the website. The email marketing functionality transforms the website into an audience-building platform by capturing visitor email addresses through strategically placed signup forms and enabling ongoing communication with subscribers through targeted email campaigns.

Email list management tools allow users to build and organize subscriber lists. Website visitors can subscribe to the user's mailing list through email signup forms integrated into various website locations including homepage sections, footer areas, dedicated contact pages, or modal pop-ups that appear based on visitor behavior such as time on site or exit intent. The signup forms may be customized in appearance, positioning, and messaging to align with the website's design and the user's audience-building objectives.

In certain embodiments, the system implements commodity-specific email perks that incentivize visitor signups by offering valuable content in exchange for email addresses. For books, users may configure incentive offerings such as downloadable excerpts from forthcoming books, free first chapters of recent releases, exclusive short stories or bonus content, early access to new release announcements, author interviews or behind-the-scenes content, or exclusive discounts on book purchases. When visitors provide their email addresses through signup forms, the system automatically delivers the promised incentive content via email, providing immediate value while capturing the subscriber for future marketing communications.

The incentive configuration interface allows users to associate specific digital content files with email signup forms. Users upload PDF files, ePub files, or other digital content formats representing the incentive material. The system securely delivers this content to new subscribers through automated welcome emails triggered immediately upon signup. This automated incentive delivery eliminates manual fulfillment while ensuring subscribers receive promised benefits promptly, enhancing signup conversion rates and subscriber satisfaction.

Email campaign creation tools enable users to compose and send email communications to their subscriber lists. The campaign composer provides email templates specifically designed for author and commodity promotion including new release announcements, book launch sequences, event invitations, special promotions or sales, content updates such as new blog posts, seasonal greetings or milestone celebrations, and re-engagement campaigns for inactive subscribers. Templates incorporate professional design layouts, mobile-responsive formatting, and proven email marketing structures that encourage reader engagement and action.

Users may customize email templates by editing text content, uploading header images or book cover graphics, adjusting color schemes to match website branding, configuring call-to-action buttons linking to purchase pages or website content, and personalizing subject lines and preview text that appear in subscriber inboxes. The email composer may support rich text formatting, image embedding, and dynamic content insertion such as subscriber names or personalized book recommendations.

In certain embodiments, the email marketing system analyzes the user's existing content, such as social media posts retrieved during initial setup as described in connection with stage 208 of FIG. 2, to suggest email campaign content written in the user's authentic voice and style. This content suggestion capability assists users who may struggle with email composition by providing starting points that maintain consistency with their established communication patterns.

Campaign scheduling and automation controls allow users to send emails immediately or schedule delivery for specific future dates and times. Automated email sequences may be configured to trigger based on subscriber actions, such as welcome email series delivered over several days following initial signup, book launch countdown sequences sent at intervals before publication dates, or post-purchase follow-up emails thanking readers and requesting reviews. Scheduling optimization may recommend sending times based on historical open rate data or industry best practices for maximum subscriber engagement.

List segmentation capabilities enable users to organize subscribers into targeted groups based on interests, engagement levels, or other attributes. For authors with multiple books across different genres, segmentation allows sending genre-specific promotional emails only to subscribers who have expressed interest in that genre, improving relevance and reducing unsubscribe rates. Segmentation may be based on signup source (which book's landing page the subscriber found), engagement history (which previous emails the subscriber opened or clicked), or explicitly collected preferences through signup form fields.

Email analytics integration with analytics dashboard 606 displays campaign performance metrics including delivery rates showing successfully delivered emails, open rates indicating what percentage of recipients opened emails, click-through rates measuring link engagement within emails, unsubscribe rates monitoring list health, and conversion metrics tracking actions such as book purchases or website visits resulting from email campaigns. These metrics inform ongoing email strategy optimization and content refinement.

Integration with third-party email service providers may be supported in certain embodiments. This integration synchronizes subscriber lists between the website and external email platforms, enabling users to leverage specialized email marketing tools while maintaining website-based signup capabilities. Alternatively, the system may provide native email delivery infrastructure eliminating the need for external email service provider accounts.

The user can also add events for display on one or more pages of the generated website. The events can include associated title, description, link to external information, images, event date, address, and other information.

Settings configuration controls within editing controls 602 provide access to technical and functional settings for the website. Settings may include domain and hosting configuration, search engine optimization (SEO) parameters such as meta descriptions and page titles, analytics integration, privacy policy and terms of service pages, cookie consent settings, security settings such as SSL certificate management, backup and restore options, and user account management for multi-user websites. The settings interface organizes these options in accessible formats appropriate for users with varying technical expertise.

Setup guide 604 displays recommended steps to finalize the website and indicates completion status for each step. The setup guide 604 provides structured guidance through the website launch process, helping users ensure they have completed essential configuration tasks before publishing or optimizing their published websites for maximum effectiveness.

In certain embodiments, setup guide 604 presents a checklist or progress indicator showing multiple recommended steps with visual indicators of completion status. For example, the guide may display steps such as: verify commodity information (completed/not completed), customize author biography (completed/not completed), configure purchase links (completed/not completed), select custom domain (completed/not completed), review website appearance (completed/not completed), and publish website (completed/not completed). Each step may be accompanied by status icons, progress bars, checkmarks, or color coding indicating whether the step has been completed.

The setup guide 604 may include interactive elements allowing users to navigate directly to the relevant configuration interfaces for each step. For example, clicking on “configure purchase links” in the setup guide 604 may open the purchase link configuration interface 800 illustrated in FIG. 8, allowing users to address that specific task efficiently. This guided workflow reduces the cognitive burden of determining what actions to take and in what sequence, accelerating the path from initial website generation to successful publication.

In certain embodiments, the setup guide 604 adapts based on the current state of the website and user actions. As users complete recommended steps, the guide updates to reflect completion status. The guide may also provide personalized recommendations based on the website's characteristics, such as suggesting specific optimizations for authors with multiple books, recommending social media integration for users with significant social followings, or highlighting SEO configuration for users seeking search engine visibility.

Analytics dashboard 606 enables users to track website performance and visitor behavior through comprehensive analytics capabilities. The analytics dashboard 606 displays metrics including visitor counts, page views, unique visitors, geographic distribution of visitors, traffic sources, and temporal patterns such as daily or weekly visitor trends. These general website analytics help users understand their audience reach and engagement levels.

In certain embodiments, analytics dashboard 606 includes commerce-specific metrics particularly relevant to commodity-focused websites. Purchase link click tracking monitors how many visitors click on purchase links for each commodity, providing insights into which commodities generate the most interest and which purchase destinations visitors prefer. This information helps users optimize purchase link placement and prioritize promotion of high-interest commodities.

Mailing list signup tracking monitors how many visitors subscribe to newsletters or mailing lists through signup forms integrated into the website. This metric helps users assess the effectiveness of their audience-building efforts and may inform content strategy or promotional activities.

The analytics dashboard 606 may display additional metrics such as average time on site, bounce rates, most-viewed pages, social media click-through rates, contact form submissions, or custom conversion goals defined by users. In certain embodiments, the analytics integrate with third-party analytics platforms, providing seamless access to comprehensive analytics capabilities within the website preview and management interface 600.

The analytics dashboard 606 may present data through various visualization formats including line graphs showing trends over time, bar charts comparing metrics across different pages or commodities, pie charts showing traffic source distributions, heat maps indicating geographic visitor concentrations, or tabular displays showing detailed breakdowns of specific metrics. Users may adjust date ranges, apply filters, or export analytics data for external analysis.

Publication controls within website preview and management interface 600 allow users to publish the website or update the published website with modifications. Before initial publication, users may activate a “Publish” button or similar control to deploy the website to the specified domain or subdomain as described in connection with stage 226 of FIG. 2. After publication, users may make edits through editing controls 602 and activate an “Update” or “Save Changes” control to push modifications to the live website. In certain embodiments, the system provides staging or preview URLs allowing users to view unpublished changes before making them publicly visible.

The website preview and management interface 600 serves as a central hub for ongoing website administration, consolidating preview, editing, guidance, and analytics capabilities in a unified interface. This integration enables efficient website management without requiring users to navigate between disparate tools or platforms. The combination of automated generation, intuitive editing controls, guided workflows, and actionable analytics empowers users to create, launch, and continuously optimize professional websites that effectively showcase their commodities and engage their audiences.

FIG. 7 illustrates an example of a user information configuration interface 700 for configuring user biographical information. This user information configuration interface 700 is accessible through the content configuration controls within editing controls 602 described in connection with FIG. 6, and enables users to customize the personal or business information displayed on their generated websites.

The user information configuration interface 700 allows users to edit, supplement, or replace the biographical information automatically retrieved by the system from social media sources or other retrieved user related information as described in connection with stage 208 and stage 212 of FIG. 2, or to populate biographical information when social media data was not provided as described in connection with stage 206 of FIG. 2. This user information configuration interface 700 provides granular control over how users present themselves to website visitors, ensuring accurate, current, and appropriately tailored self-representation.

In certain embodiments, the user information configuration interface 700 includes a biographical text editor that allows users to compose or modify biographical narratives. The editor may present the automatically retrieved biographical text from social media profiles as default content, which users can accept, edit, or completely rewrite. For users who did not provide social media information during initial setup, the editor may present blank fields or template prompts suggesting biographical elements to include, such as professional background, achievements, interests, or personal story.

When users do not provide biographical text or when biographical text was automatically retrieved from social media, but the user wishes to generate alternative versions, the system may offer AI-assisted biographical content generation. The system analyzes the user's writing style from social media posts, published works, or other available materials as described in connection with stage 208 and stage 212 of FIG. 2, and generates biographical narratives that reflect the user's authentic voice and communication characteristics. Users may specify the desired length (short bio, full bio, professional summary) and context (casual vs. formal), and the system generates appropriate biographical content matching both the specified parameters and the user's established writing style. This AI-generated biographical content provides users with professionally written starting points that they can accept, refine, or use as inspiration, reducing the burden of self-promotion writing while maintaining authentic self-representation.

The biographical text editor may support rich text formatting capabilities including bold, italic, underline, bullet points, numbered lists, headings, and hyperlinks, allowing users to structure and emphasize biographical content effectively. In certain embodiments, the editor includes multiple biographical text fields for different contexts, such as a short biography (for homepage display or compact sections), a full biography (for dedicated about pages), and a professional summary (emphasizing credentials or achievements). Users may compose different versions appropriate for different placements within the website.

Profile image management controls allow users to upload, select, or modify profile photographs or business logos displayed on the website. Users may upload image files from their computing devices, including photographs in common formats such as JPEG, PNG, or GIF. The user information configuration interface 700 may provide image editing tools including cropping, rotation, resizing, brightness and contrast adjustment, or filters to optimize image appearance.

In certain embodiments, when social media information was provided during setup, the profile image automatically retrieved from the user's social media profile is displayed as the default option. Users may accept this automatically retrieved image or upload alternative images. The user information configuration interface 700 may allow users to upload multiple profile images and designate which image appears in different website contexts, such as using a formal headshot for the about page while using a casual photograph for blog posts or social media sections.

The profile image controls may include specifications or recommendations regarding image dimensions, aspect ratios, or file sizes optimized for web display. For example, the user information configuration interface 700 might recommend square profile images of at least 400×400 pixels for optimal display quality across different page elements and device sizes. The system may automatically optimize uploaded images for web performance, compressing file sizes while maintaining visual quality.

Contact detail configuration controls allow users to specify how visitors can reach them. Contact details may include email addresses, phone numbers, mailing addresses, business locations, or other contact methods. The user information configuration interface 700 provides input fields for each contact detail type, and allows users to control whether each detail is displayed publicly on the website or used only for backend contact form delivery.

In certain embodiments, the user information configuration interface 700 includes privacy controls allowing users to specify different levels of contact information visibility. For example, a user might choose to display a contact form without revealing their email address directly, or might display a business phone number while keeping a personal mobile number private. The system configures the website's contact sections and contact forms according to the specified privacy preferences.

Social media link configuration controls allow users to add, modify, or remove links to their social media profiles. The user information configuration interface 700 may present input fields for various social media platforms including Instagram, Facebook, Twitter, LinkedIn, TikTok, YouTube, Pinterest, Goodreads (particularly relevant for authors), and others. When social media information was provided during initial setup as described in connection with stage 208 of FIG. 2, the specified social media profile is automatically linked. Users may add links to additional social media platforms or modify existing links.

The social media configuration may include options for how social media links are displayed on the website, such as icon-based links in headers or footers, social media feed embeds displaying recent posts, follower count displays, or social sharing buttons enabling visitors to share website content on their own social networks. Users may customize which social media platforms are prominently featured based on where they maintain active presences and wish to drive visitor engagement.

Professional information sections allow users to specify credentials, achievements, affiliations, or other information establishing expertise or credibility. For authors, professional information might include writing awards, publication credits, literary agent representation, membership in writers' organizations, speaking engagements, or academic credentials. For other creators or merchants, professional information might include certifications, industry affiliations, press mentions, awards, or business credentials.

The user information configuration interface 700 may provide structured input fields for different types of professional information, such as award name and year, organization affiliation and role, publication title and date, or credential designation and issuing authority. This structured approach enables the system to format professional information consistently and attractively on the generated website.

In certain embodiments, the user information configuration interface 700 includes a preview panel or preview mode that displays how the biographical information, profile images, contact details, and professional information will appear on the actual website. The preview updates dynamically as users make edits, providing immediate visual feedback regarding how changes affect the website presentation. Users may toggle between editing view and preview view, or view both simultaneously in split-screen layouts.

The user information configuration interface 700 includes save or update controls that allow users to apply changes to the website. For unpublished websites, the save control stores the modified user information for inclusion when the website is published. For already-published websites, the update control pushes the modified information to the live website, making changes immediately visible to visitors. In certain embodiments, the system provides options to save changes as drafts without immediately publishing them, allowing users to prepare updates and review them before making them public.

Validation and error checking may be implemented to ensure entered information meets format requirements. For example, the system may verify that email addresses follow proper formatting, that uploaded images meet minimum quality standards, or that required fields are completed before allowing users to save changes. Validation feedback is presented through error messages, highlighting, or tooltips guiding users to correct issues.

The user information configuration interface 700 may be accessed at any point in the website lifecycle, from initial setup through ongoing website management. Users may update biographical information as their careers progress, upload new profile images periodically, add newly won awards or achievements, or modify contact preferences as circumstances change. This flexibility ensures that websites remain current and accurately represent users over time.

By providing comprehensive yet accessible controls for user information customization, the user information configuration interface 700 enables users to craft authentic, professional self-presentations that complement the automatically retrieved commodity information and enhance overall website effectiveness in connecting with audiences and promoting commodities.

FIG. 8 illustrates an example of a purchase link configuration interface 800 for configuring purchase links for commodities. This interface is accessible through the commodity configuration controls within editing controls 602 described in connection with FIG. 6, and provides comprehensive tools for specifying where website visitors can purchase the displayed commodities. The purchase link configuration interface 800 enables users to maximize sales opportunities by connecting visitors to multiple retail platforms, direct purchase options, or custom destinations appropriate for the specific commodity type.

Purchase link configuration interface 800 presents options for configuring purchase destinations associated with each commodity displayed on the website. In certain embodiments, the interface displays a list or grid of the user's commodities, allowing users to select a specific commodity for purchase link configuration. Once a commodity is selected, the interface presents purchase link configuration options specific to that commodity, enabling per-commodity customization of available purchase destinations.

The purchase link configuration interface 800 includes retail platform selection controls that present options for major retail platforms and online stores relevant to the commodity type. For book-related commodities, retail platform options may include Amazon, Barnes & Noble, Books-A-Million, IndieBound (supporting independent bookstores), Book Depository, Powell's Books, Kobo, Apple Books, Google Play Books, and other booksellers. For other commodity types, platform options may include appropriate e-commerce marketplaces such as eBay, Etsy, Shopify stores, or category-specific platforms.

In certain embodiments, the system automatically retrieves purchase links for the user's commodities from retail platforms using the commodity identifiers provided during initial setup. For example, when a user provided an ISBN as described in connection with stage 202 of FIG. 2, the system may query retail platform APIs or construct standard product URLs to generate direct links to the book's product page on Amazon, Barnes & Noble, and other retailers. These automatically generated purchase links are presented in the interface as default options, populated with checkboxes, toggle switches, or similar controls indicating which platforms are currently enabled for display on the website.

Users may activate or deactivate specific retail platforms by toggling the associated controls, determining which purchase options are presented to website visitors. For example, an author might choose to enable purchase links for Amazon, IndieBound, and Apple Books while disabling other platforms, ensuring the website directs visitors only to preferred retail partners. The system configures the generated website to display purchase buttons or links only for the enabled platforms.

Custom purchase link controls allow users to add purchase destinations not included in the predefined retail platform options. Users may enter custom URLs directing visitors to any desired destination, such as the user's own e-commerce website, a publisher's direct sales page, a crowdfunding platform, an event ticketing site, or specialized retailers. Custom link configuration may include fields for specifying the link URL, display text or button label, and optional visual elements such as logos or icons representing the destination.

In certain embodiments, the purchase link configuration interface 800 includes affiliate link configuration capabilities. Affiliate programs offered by retailers such as Amazon Associates allow users to earn commissions on purchases made through specially formatted affiliate links. The interface may provide fields for entering affiliate identifiers, partner codes, or tracking parameters, and the system automatically constructs properly formatted affiliate links incorporating these parameters. This enables users to monetize their website traffic while directing visitors to purchase destinations. The interface may include informational text or links explaining affiliate program requirements and registration processes for users unfamiliar with these programs.

Pricing information display controls allow users to specify whether commodity prices are displayed on the website alongside purchase links. When enabled, the system may automatically retrieve current pricing information from retail platforms using commodity identifiers or platform APIs. Users may choose to display prices from specific retailers, average prices across multiple retailers, or price ranges when prices vary across platforms. Price display configuration may include options for formatting, currency selection, and update frequency to ensure displayed prices remain current.

Availability status configuration allows users to indicate whether commodities are currently available for purchase, on pre-order, out of stock, or available only in certain formats or editions. The availability status may be displayed prominently near purchase links, informing visitors before they click through to retail platforms. In certain embodiments, the system automatically retrieves availability information from retail platforms, updating the website dynamically as availability changes.

Purchase link display customization controls allow users to configure how purchase links appear visually on the website. Options may include button styling (such as color, size, shape, and text), icon inclusion (displaying retailer logos or generic shopping cart icons), link positioning (such as prominently featured on commodity pages versus compact link lists in footers), and layout arrangements for multiple purchase options (such as horizontal button rows, vertical lists, or dropdown menus).

In certain embodiments, the purchase link configuration interface 800 includes priority or ordering controls allowing users to specify the sequence in which purchase links are displayed. For example, a user might prioritize independent bookstore options over large retailers by adjusting link positioning, reflecting values or business relationships. The system applies the user-specified ordering when rendering purchase link sections on the website.

Format-specific purchase link configuration enables users to specify different purchase destinations for different commodity formats. For books, users might configure separate purchase links for hardcover, paperback, e-book, and audiobook formats, directing visitors to retailers offering each specific format. The website displays format selection options allowing visitors to choose their preferred format and access corresponding purchase links.

International purchase link configuration allows users to specify purchase destinations for visitors in different geographic regions. For example, an author might configure Amazon.com links for United States visitors, Amazon.co.uk links for United Kingdom visitors, and regional equivalents for other countries. In certain embodiments, the system can detect visitor location through IP geolocation and automatically display regionally appropriate purchase links, optimizing the purchase experience for international audiences.

The purchase link configuration interface 800 may include analytics integration showing click-through data for each purchase destination. Users can view which purchase links receive the most clicks, informing decisions about which platforms to prioritize or whether to add additional purchase options. This analytics capability connects to the analytics dashboard 606 described in connection with FIG. 6, providing actionable insights into visitor purchasing behavior.

Bulk configuration controls allow users to apply purchase link settings across multiple commodities simultaneously. For example, if a user wants to enable Amazon and IndieBound links for all books in their catalog, bulk configuration tools enable this without requiring individual configuration of each commodity.

The purchase link configuration interface 800 includes save or update controls that apply the configured purchase links to the website. Changes may be saved as drafts for review before publication, or immediately pushed to live websites for already-published sites. Validation ensures that entered URLs are properly formatted and that required fields are completed before saving.

Preview functionality within the interface allows users to see how configured purchase links will appear on the actual website. The preview shows the visual styling, positioning, and arrangement of purchase buttons or links as visitors will experience them, enabling users to assess effectiveness and make adjustments before finalizing configuration.

By providing comprehensive purchase link configuration capabilities, purchase link configuration interface 800 enables users to optimize the conversion pathway from visitor interest to commodity purchase. The combination of automatically retrieved retail links, custom destination options, affiliate integration, and display customization empowers users to create effective purchase experiences aligned with their business objectives, retail relationships, and audience preferences. This functionality directly supports the website's purpose of promoting and facilitating commodity sales, translating website traffic into revenue opportunities.

FIG. 9 illustrates an example of a commodity management interface 900, here a display page showing multiple commodities. This interface is accessible through the commodity configuration controls within editing controls 602 described in connection with FIG. 6, and provides tools for organizing, arranging, and configuring how commodities are displayed on the generated website. Commodity management interface 900 enables users to structure their commodity presentations effectively, creating intuitive browsing experiences for website visitors.

Commodity management interface 900 presents a visual representation of how commodities appear on the website, showing the actual commodity catalog as visitors will experience it. For author websites featuring multiple books, the interface displays book covers, titles, and associated metadata in the configured layout. For other commodity types, the interface displays relevant product images, names, and information. The interface provides both viewing and organizational capabilities, allowing users to assess the current commodity display while making structural adjustments.

In certain embodiments, the commodity management interface 900 includes layout selection controls that determine the visual arrangement of commodities on commodity catalog pages. Layout options may include grid layouts displaying commodities in multi-column arrangements (such as two-column, three-column, or four-column grids), list layouts presenting commodities in single-column vertical lists with larger images and expanded information, gallery layouts emphasizing visual presentation with minimal text, carousel or slider layouts allowing visitors to browse through commodities horizontally, and featured layouts highlighting specific commodities prominently while showing others in secondary positions.

Users may select among available layout options through visual thumbnails, dropdown menus, or radio button controls. The interface provides preview functionality showing how each layout option affects commodity display, enabling informed selection. Different layout options may be appropriate for different commodity quantities, image qualities, or user objectives. For example, grid layouts efficiently display large commodity catalogs, while featured layouts effectively highlight a single primary commodity supplemented by additional works.

Commodity ordering controls allow users to specify the sequence in which commodities appear on the website. The interface may present the current commodity list with drag-and-drop functionality enabling users to reposition commodities by dragging them to desired positions. Alternative ordering controls may include up/down arrow buttons, numerical position fields, or automated sorting options.

Automated sorting options enable users to order commodities according to various criteria including publication date (newest first or oldest first), title (alphabetical order), popularity (based on analytics data such as page views or purchase link clicks), price (ascending or descending), or custom priority scores assigned by users. For author websites, users might choose to display their most recent book first to emphasize new releases, or might arrange books chronologically to show career progression. The system applies the selected ordering when rendering commodity catalog pages.

Category and collection management controls allow users to organize commodities into logical groupings that facilitate visitor navigation and discovery. Categories represent broad classifications such as genre, product type, topic area, or intended audience. For author websites, categories might include fiction, non-fiction, children's books, short stories, or genre-specific designations like mystery, romance, or science fiction. For other commodity types, categories might represent product lines, price ranges, or usage contexts.

The commodity management interface 900 provides tools for creating new categories, assigning commodities to categories, and managing category properties such as category names, descriptions, and display ordering. Users may assign individual commodities to one or multiple categories. For example, a book might be categorized as both “Fiction” and “Award Winners,” appearing in both category views on the website.

Collections represent curated groupings of related commodities that may transcend categorical boundaries. Collections enable users to create thematic groupings, series, bundles, or promotional sets. For example, an author might create a collection called “The Riverside Series” containing all books in a specific series, or “Summer Reading Picks” featuring selected books appropriate for seasonal promotion. Collections provide flexible organizational tools that complement categorical structure.

The commodity management interface 900 includes collection creation and management tools allowing users to define collection names, descriptions, and visual elements such as collection banner images or icons. Users assign commodities to collections through selection controls such as checkboxes, drag-and-drop operations, or multi-select interfaces. The system generates dedicated collection pages displaying the grouped commodities with the specified collection context.

Visibility and display controls allow users to specify which commodities are displayed on the website and how prominently they are featured. Users may temporarily hide specific commodities without deleting them, such as when books are temporarily out of print or products are undergoing updates. Featured status controls enable users to designate specific commodities for prominent display on the homepage, in hero sections, or in special promotional positions.

In certain embodiments, the commodity management interface 900 includes badge or label configuration allowing users to apply visual indicators to commodities. Badges might indicate status such as “New Release,” “Bestseller,” “Award Winner,” “Limited Edition,” or “On Sale.” Users may select from predefined badge options or create custom badges with specified text, colors, and icons. The badges appear overlaid on commodity images or displayed near commodity titles, drawing visitor attention to highlighted commodities.

Display format controls allow users to specify what information is shown for each commodity in catalog views. Options may include showing or hiding elements such as commodity titles, subtitles, author or creator names, cover images or product photos, brief descriptions or taglines, publication dates or release dates, pricing information, format availability (hardcover, paperback, e-book, etc.), review ratings or testimonials, and purchase links.

By customizing which information elements are displayed, users can create compact displays that show many commodities efficiently or expanded displays that provide more context for each commodity. The display format configuration may be applied consistently across the commodity catalog, helping to ensure visual coherence while allowing per-commodity customizations.

Responsive design preview controls allow users to view how commodity displays adapt to different device types and screen sizes. Users may toggle between desktop, tablet, and mobile previews to verify that grid layouts reflow appropriately, images scale correctly, and commodity information remains readable across devices. Device-specific adjustments may be configured to optimize display for each device category.

In certain embodiments, commodity management interface 900 includes filtering and search configuration controls that determine what filtering and search capabilities are available to website visitors. Users may enable category filters, price range filters, format filters, availability filters, or custom attribute filters allowing visitors to narrow displayed commodities based on their interests. Search functionality configuration determines whether visitors can search commodities by title, keyword, author, or other attributes.

Navigation configuration controls allow users to specify how visitors navigate between commodity catalog pages and individual commodity detail pages. Options include navigation menu placement (such as sidebar menus, top navigation bars, or footer links), breadcrumb navigation showing the user's position within categorical hierarchies, pagination controls for multi-page commodity catalogs, or infinite scroll implementations that load additional commodities as visitors scroll.

Bulk action controls enable users to apply changes to multiple commodities simultaneously. Users may select multiple commodities through checkboxes or selection modes and perform bulk operations such as assigning selected commodities to categories or collections, applying visibility settings, updating display settings, or performing other administrative tasks. Bulk actions improve efficiency for users managing large commodity catalogs.

The commodity management interface 900 includes save or update controls that apply organizational and display configuration changes to the website. For unpublished websites, changes are saved for inclusion when the website is published. For published websites, changes are pushed to the live site, updating commodity displays immediately or after user confirmation.

Integration with the analytics dashboard 606 described in connection with FIG. 6 may provide performance data for different commodities, categories, or collections. Users can view which commodities receive the most page views, which categories are most frequently browsed, or which display arrangements correlate with increased purchase link clicks. This data-driven insight informs optimization decisions regarding commodity organization and display.

For detailed editing of individual commodity information, including modifying descriptions, uploading images, updating metadata, or adding new commodities to the catalog, users access the commodity detail editing interface 1000 illustrated in FIG. 10. The commodity management interface 900 focuses on organizational and display aspects affecting how commodities appear collectively, while FIG. 10 addresses the content and attributes of individual commodity entries.

By providing comprehensive commodity organization and display management capabilities, commodity management interface 900 enables users to create intuitive, visually appealing commodity presentations that facilitate visitor discovery and engagement. The combination of flexible layout options, category and collection organization, display customization, and visitor navigation tools empowers users to structure their commodity catalogs effectively, supporting the website's objectives of showcasing commodities attractively and driving purchase conversions.

FIG. 10 illustrates an example of a commodity detail editing interface 1000 for editing individual commodity information. This interface is accessible by selecting a specific commodity from the commodity management interface 900 described in connection with FIG. 9, or through the commodity configuration controls within editing controls 602 described in connection with FIG. 6. Commodity detail editing interface 1000 provides comprehensive tools for modifying commodity content, metadata, images, and settings at the individual commodity level, enabling users to refine, supplement, or customize the information automatically retrieved during website generation.

Commodity detail editing interface 1000 presents editable fields and controls populated with the commodity information retrieved from data sources as described in connection with stage 212 of FIG. 2. Users may accept the automatically retrieved information, make modifications to improve accuracy or presentation, or replace automated content with custom information. The interface also enables users to add entirely new commodities to their website catalog that were not included during initial setup.

In certain embodiments, the commodity detail editing interface 1000 includes a mode selection control allowing users to toggle between editing existing commodities and adding new commodities. When editing an existing commodity, the interface displays the current commodity information in editable fields. When adding a new commodity, the interface presents blank fields for manual entry or provides options to retrieve information automatically by entering a new commodity identifier.

For adding new commodities, the commodity detail editing interface 1000 includes a commodity identifier input field similar to identifier input field 302 described in connection with FIG. 3. Users may enter an ISBN, EAN, UPC, book title, URL, or other standardized product identification code. Upon entering a valid identifier and activating a retrieval control, the system queries data sources as described in connection with stage 212 of FIG. 2 to automatically retrieve commodity information including title, author or creator, publication or release date, description, images, reviews, and other metadata. The retrieved information populates the interface fields, which users may then review and customize before adding the commodity to their website catalog.

Alternatively, users may add commodities through manual information entry without providing commodity identifiers. This accommodates commodities lacking standardized identification codes, such as self-published books without ISBNs, handmade products, custom creations, or upcoming releases not yet available in public databases. Users manually complete the interface fields to define the commodity, and the system adds it to the website catalog based on the user-provided information.

Title and subtitle fields allow users to specify or modify the commodity's display name. For books, these fields contain the book title and subtitle retrieved from databases. Users may edit the title for stylistic preferences, correct errors in automated retrieval, or provide titles for manually added commodities. The title field typically represents the primary identifying name displayed prominently on commodity pages and in catalog listings. The subtitle field, when applicable, provides additional context or series information.

Author or creator fields specify the commodity's creator, such as author name for books, artist name for artwork, musician name for albums, or manufacturer for products. The automatically retrieved author name may be edited to reflect preferred name formats, pen names, or multiple author credits. For co-authored works, users may list multiple creators with appropriate attribution.

Description editor provides text input capabilities for commodity descriptions or synopses. For books, the description typically includes the book synopsis or jacket copy retrieved from publisher databases or retail platforms. The description editor may support rich text formatting including paragraphs, bold, italic, bullet points, and other formatting that enhances readability and emphasis.

In certain embodiments, the description editor includes AI-assisted content generation capabilities that draft commodity descriptions based on automatically retrieved information while matching the user's writing style. The system combines commodity details retrieved from data sources with the user's characteristic tone and vocabulary identified through style analysis described in connection with stage 208 and stage 212 of FIG. 2. For books, the AI may generate descriptions that incorporate plot elements, thematic content, or genre characteristics from retrieved synopses while expressing these elements in the author's authentic voice rather than generic publisher language. Users may generate multiple description variants with different lengths, tones, or emphasis points, selecting or refining the version that best suits their needs. This AI-generated content supplements or replaces automatically retrieved publisher descriptions, providing personalized alternatives that better reflect how the author would naturally describe their own work.

Users may edit automatically retrieved descriptions to adjust tone, length, or content emphasis. Some users prefer shorter, punchier descriptions for website display compared to lengthy publisher synopses. Others may add personal commentary, author insights, or context not included in standard book descriptions. The description appears on individual commodity detail pages and may appear in abbreviated form in catalog listings depending on display settings (e.g., configured in commodity management interface 900).

Image management controls allow users to upload, select, or modify commodity images. For books, the primary image is typically the book cover, automatically retrieved from publisher or retailer databases during initial data aggregation. Users may replace the automatically retrieved cover image with higher resolution versions, alternate cover designs for different editions, or custom images.

The commodity detail editing interface 1000 may provide multiple image upload capabilities allowing users to add supplementary images beyond the primary cover or product photo. Additional images might include interior page samples for books, alternate product angles, packaging photos, detail shots, or contextual lifestyle images showing products in use. Users may designate which image serves as the primary display image and specify ordering for additional images displayed in galleries or slideshows on commodity detail pages.

Image upload controls accept common image formats such as JPEG, PNG, and GIF. The interface may include image editing tools for cropping, rotating, resizing, or adjusting brightness and contrast. Recommendations regarding optimal image dimensions, aspect ratios, or file sizes may be provided to ensure high-quality display while maintaining website performance. The system may automatically optimize uploaded images for web delivery, generating responsive image versions for different device types and screen sizes.

Metadata fields allow users to specify or edit detailed commodity information used for categorization, filtering, and search. Metadata fields may include. Publication or release date, which may be automatically retrieved and displayed for editing. Users can specify dates for upcoming releases, update dates when publication schedules change, or provide dates for older works not accurately reflected in databases. Metadata fields can also include ISBN, EAN, UPC, or other identifier fields displaying the commodity identification codes. While these are typically provided during initial setup or retrieval, users may add alternate identifiers such as multiple ISBNs for different editions (hardcover, paperback, e-book) or international product codes. Additional fields include publisher or manufacturer information specifying the producing entity. For books, this includes publisher name and imprint. Users may edit publisher information or add details not captured in automated retrieval.

The metadata fields can include format or edition information specifying whether the commodity is a hardcover, paperback, e-book, audiobook, or other format variant. Users may designate multiple formats when the commodity is available in various editions, with the interface linking to appropriate purchase destinations for each format. Additionally, page count, runtime, dimensions, weight, or other physical specifications relevant to the commodity type can be included. These details help visitors assess the commodity characteristics. Further metadata fields include genre, category, or classification tags that associate the commodity with relevant categories, such as configured in commodity management interface 900. Users may select from existing categories or create new categories. Multiple category assignments allow commodities to appear in various categorical groupings throughout the website.

Review and testimonial management controls allow users to add, edit, or manage reviews and testimonials displayed on commodity pages. The system may automatically retrieve published reviews from review aggregation sources during initial data retrieval as described in connection with stage 212 of FIG. 2. Users may supplement automatically retrieved reviews with additional testimonials, reader feedback, professional endorsements, or award recognitions. For each review or testimonial, users may specify the review text, reviewer name, reviewer credentials or affiliation, source publication or platform, review date, and optional rating scores. Users may select which reviews to display prominently on commodity pages, arrange review ordering, or configure review display formatting. This curated presentation of reviews enhances commodity credibility and provides social proof encouraging purchases.

Award and recognition fields allow users to specify honors received by the commodity, such as literary awards for books, industry accolades for products, or bestseller status. Award information may be displayed with badges, banners, or dedicated sections on commodity detail pages, differentiating recognized commodities and building visitor confidence.

Purchase link configuration specific to the individual commodity provides access to the purchase link controls described in connection with FIG. 8. Users may configure retail platforms, affiliate links, pricing display, and custom purchase destinations for the specific commodity being edited. This per-commodity configuration enables different purchase strategies for different commodities. For example, a new release might feature prominent Amazon links with affiliate codes, while an older title might prioritize independent bookstore links.

Availability and status controls allow users to specify the commodity's current availability such as available, pre-order, out of stock, discontinued, or coming soon. The selected status is displayed on commodity pages and catalog listings, managing visitor expectations and preventing frustration from attempting to purchase unavailable items. Users may provide estimated availability dates for pre-orders or restocking.

Visibility settings determine whether the commodity is publicly displayed on the website or hidden. Users may temporarily hide commodities without permanently deleting them, such as when preparing upcoming release announcements or removing discontinued products while preserving historical records. Hidden commodities remain in the system and can be made visible through simple toggle controls.

Featured and priority settings allow users to designate commodities for prominent homepage display, special promotional sections, or priority ordering in catalog listings. These settings work in conjunction with the display configuration in commodity management interface 900 to ensure important commodities receive appropriate emphasis.

Custom fields or attributes enable users to add commodity-specific information not covered by standard fields. For example, an author might add fields for series information, reading order, target age range for children's books, or trigger warnings. These custom attributes may be displayed on commodity detail pages and potentially used for filtering or search if configured through commodity management interface 900.

SEO configuration controls allow users to optimize individual commodity pages for search engine visibility. Users may specify custom page titles, meta descriptions, URL slugs, and keyword tags specific to each commodity. Optimized SEO parameters improve the likelihood that visitors discover commodity pages through search engines, expanding audience reach beyond direct website traffic.

Preview functionality within the interface shows how the commodity will appear on the actual website. The preview displays the commodity detail page with all configured information, images, purchase links, and reviews as visitors will experience them. Preview modes may include desktop and mobile views, ensuring appropriate display across device types. The preview updates dynamically as users make edits, providing immediate visual feedback.

Validation and error checking ensure that required fields are completed and that entered information meets format requirements. The system may highlight incomplete fields, flag potential issues such as missing images or blank descriptions, or verify that identifiers follow proper formatting. Validation feedback guides users to address issues before saving changes.

Save and update controls allow users to apply changes to the commodity. For new commodities being added, the save control adds the commodity to the website catalog and makes it available for display according to visibility settings. For existing commodities being edited, the update control applies modifications. Changes may be saved as drafts for review or immediately published to live websites depending on user preference and system configuration.

Delete or remove controls allow users to permanently delete commodities from the website catalog when they are no longer relevant. The interface may require confirmation before deletion to prevent accidental removal. In certain embodiments, deleted commodities are archived rather than permanently removed, allowing for restoration of the commodities.

Bulk editing capabilities may be available when multiple commodities require similar changes. Users might apply category assignments, update publisher information, or modify display settings across multiple commodities simultaneously, accessed through the bulk action controls described in connection with commodity management interface 900.

Integration with analytics from analytics dashboard 606 described in connection with FIG. 6 may display performance metrics for the specific commodity, such as page views, purchase link clicks, or visitor engagement time. This data helps users assess which commodities generate the most interest and may inform decisions about featuring, promoting, or updating specific commodities.

The commodity detail editing interface 1000 provides the granular control necessary for precise commodity presentation while leveraging the efficiency of automated information retrieval. Users benefit from comprehensive commodity data automatically populated during website generation, with full capability to refine, customize, or supplement that data according to their specific needs and preferences. This balance of automation and customization ensures commodity accuracy, completeness, and effective presentation, supporting the website's objectives of showcasing commodities attractively and facilitating purchase decisions.

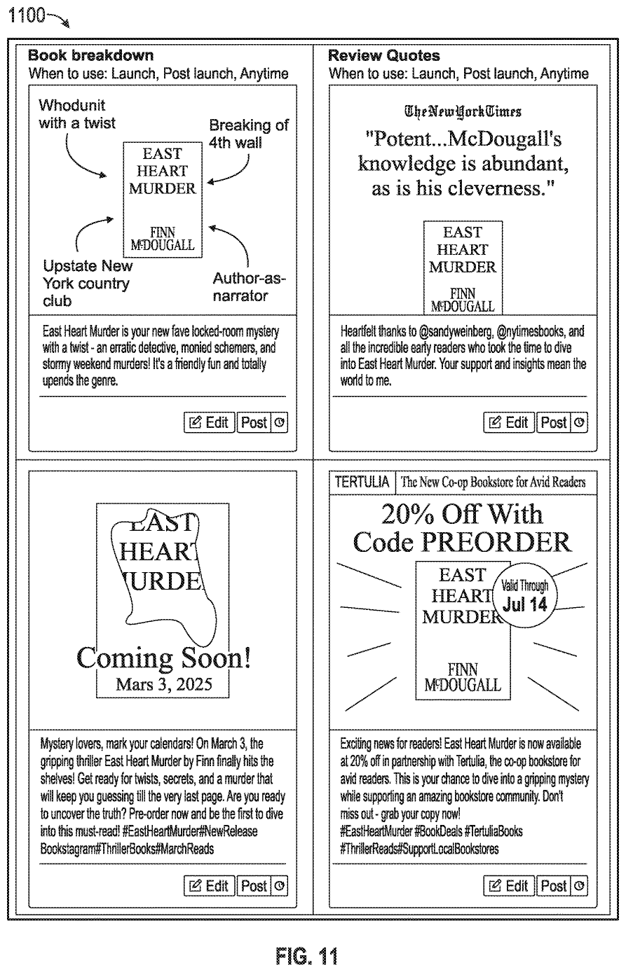

FIG. 11 illustrates an example of a social media post recommendation interface 1100 for generating and managing recommended social media posts. Social media post recommendation interface 1100 is accessible through the content configuration controls within editing controls 602 described in connection with FIG. 6, and provides automated social media content generation tools that help users promote their commodities and website across various social media platforms. This interface leverages the commodity information, user profile data, and website content aggregated during website generation to create relevant, engaging social media posts tailored to the user's specific circumstances and objectives.

Social media post recommendation interface 1100 analyzes available information from multiple sources to generate intelligent, personalized post recommendations written in the user's authentic voice and style. Data sources include the commodity information retrieved as described in connection with stage 212 of FIG. 2, such as book titles, descriptions, cover images, publication dates, reviews, and genre information. Critically, the system also analyzes the user's existing social media content retrieved during initial setup as described in connection with stage 208 of FIG. 2, examining the tone, vocabulary, sentence structure, emoji usage, hashtag patterns, and stylistic characteristics of the user's historical posts to understand their unique communication style.

In certain embodiments, the system employs machine learning models, natural language processing algorithms, or AI-based text generation capabilities to learn and replicate the user's writing style. The system analyzes a corpus of the user's social media posts and other relevant information (e.g., books, articles, and other publications authored by the user), identifying linguistic patterns including common phrases or expressions the user employs, sentence length and complexity preferences, formality level ranging from casual conversational tone to professional business tone, use of humor, enthusiasm, or other emotional characteristics, first-person versus third-person perspective preferences, and characteristic vocabulary choices that distinguish the user's voice.

The system may also analyze content from the user's books or other commodities to extract thematic elements, key messaging points, character names or concepts, quotable passages, and subject matter expertise that can be referenced in social media posts. For authors, the system may identify compelling excerpts, thematic hooks that resonate with target audiences, character introductions or dramatic moments suitable for social media sharing, or philosophical themes explored in the work. This content analysis ensures generated posts accurately represent the commodity while maintaining authentic connection to the source material.

By combining stylistic analysis of the user's existing social media presence with content analysis of their commodities, the system generates post recommendations that simultaneously sound authentically like the user and effectively promote their work. This dual analysis distinguishes the system from generic social media tools that produce formulaic content lacking personal voice or commodity-specific relevance.

In certain embodiments, the system may also query external data sources to identify trending topics, relevant hashtags, industry news, seasonal themes, or promotional opportunities that align with the user's commodities and audience. For example, the system might identify that a user's thriller novel aligns with popular mystery-related hashtags currently trending, or that an upcoming holiday presents promotional opportunities for specific commodity categories.

The interface presents multiple recommended social media posts generated by the system based on the analyzed information. Each recommended post includes suggested text content, recommended images or media, proposed posting platforms, and optional scheduling suggestions. The recommendations span various post types and purposes, providing diverse content options for the user's social media strategy.

Post type categories may include new release announcements highlighting newly published books or newly added commodities to the website, promotional posts featuring special offers, discounts, or limited-time opportunities, content sharing posts directing followers to blog content, reviews, or other website pages, engagement posts asking questions or encouraging follower interaction, milestone celebrations announcing achievements such as sales milestones, award wins, or follower count thresholds, behind-the-scenes content providing personal insights into the creative process or business operations, and user-generated content requests encouraging followers to share their experiences with the commodities.

For each recommended post, the interface displays suggested post text generated using AI or machine learning models trained on the user's communication style. The text is composed to sound authentically like the user's own writing, incorporating their characteristic tone, vocabulary, and stylistic elements while effectively communicating key messages about their commodities. For example, if a user's existing Instagram posts demonstrate casual, enthusiastic tone with frequent emoji usage and conversational language, the generated post recommendations will mirror this style rather than adopting generic professional marketing language. Conversely, if a user's social media presence reflects formal, literary tone with minimal emojis and sophisticated vocabulary, generated posts will align with this established voice.

The AI-generated post text incorporates relevant commodity content extracted from book descriptions, synopses, reviews, or other source materials, integrating this information naturally within the user's stylistic framework. For a thriller novel, the system might generate suspenseful, teasing language that mirrors the author's established tone while highlighting the book's tension and intrigue. For a cookbook, generated posts might employ warm, inviting language describing recipes or cooking experiences in the author's characteristic style.

The text generation process may employ large language models fine-tuned on the user's writing samples, template-based systems populated with user-specific vocabulary and phrasing patterns, or hybrid approaches combining AI generation with rule-based customization. The sophistication of style matching may improve as the system accumulates more samples of the user's writing through ongoing social media analysis or through analysis of blog posts, website content, or other written materials created through the platform.

Generated post text is appropriately formatted for social media conventions and tailored to specific platform characteristics. Twitter posts respect character limits and may include abbreviated text or strategic phrasing for conciseness. Instagram posts may feature longer captions with strategic line breaks, storytelling elements, and emoji usage aligned with the platform's visual-first, narrative-driven culture. LinkedIn posts may adopt more professional framing while maintaining the user's authentic voice. The system adapts both content and style to platform-specific best practices while preserving the user's essential communication characteristics.

Users may edit the AI-generated post text through text editing controls, allowing refinement, personalization, or correction of any elements that don't perfectly capture their intended message. The interface may provide character count indicators showing remaining characters for platforms with length restrictions, and may highlight when edits exceed platform limits. As users make edits to generated posts, certain embodiments may employ reinforcement learning or feedback mechanisms where the system learns from user modifications, progressively improving future recommendations to better match user preferences and reduce the need for manual editing.

Image and media recommendations accompany each post suggestion. The system may recommend commodity images such as book covers retrieved during initial data aggregation, user profile images from the biographical information described in connection with FIG. 7, website screenshots showcasing the generated website, quote graphics featuring excerpts or testimonials, or custom graphics generated by the system incorporating commodity information and branding elements.

Users may accept the recommended image, select alternative images from their commodity catalog or uploaded media library, or upload new images specifically for the social media post. The interface may provide image editing tools including cropping, filters, text overlay capabilities, or resizing to optimize images for different platform specifications such as Instagram square format, Facebook landscape format, or Twitter card dimensions.

Platform selection controls allow users to specify which social media platforms each post should be published to. Platform options may include Instagram, Facebook, Twitter, LinkedIn, TikTok, Pinterest, Goodreads, or other platforms where the user maintains presence. The social media connections may utilize the social media information provided during initial setup as described in connection with decision point 204 and stage 208 of FIG. 2, or users may connect additional social media accounts through authentication and authorization processes.

In certain embodiments, the interface provides platform-specific customization, recognizing that different platforms have different best practices, audience demographics, and content conventions. Users may customize post text, images, or hashtags differently for each platform while maintaining thematic consistency. The system may generate platform-specific variations of the same core message, optimizing each version for its target platform.

Hashtag recommendations are provided based on commodity genre, trending topics, industry-standard tags, and platform-specific popular hashtags. For author posts, recommendations might include genre hashtags like #ThrillerBooks or #SciFiReads, reading community hashtags like #BookLovers or #Bookstagram, promotional hashtags like #NewRelease or #MustRead, or custom branded hashtags specific to the user or commodity series. Users may accept suggested hashtags, remove unwanted tags, or add custom hashtags. The interface may indicate hashtag popularity or reach potential to inform selection decisions.

Scheduling controls allow users to specify when posts should be published. Users may post immediately upon creation or schedule posts for future dates and times. The interface may provide scheduling recommendations based on analytics of optimal posting times for audience engagement, such as suggesting times when the user's followers are most active on each platform. Calendar views or timeline interfaces facilitate scheduling multiple posts across extended periods, enabling users to plan comprehensive social media campaigns.

In certain embodiments, the social media post recommendation interface 1100 includes automation capabilities that generate and schedule recurring posts according to user-defined patterns. For example, users might configure weekly posts highlighting different books from their catalog, monthly posts sharing writing tips or industry insights, or automated posts triggered by specific events such as commodity milestones or website analytics achievements.

Post preview functionality displays how each post will appear on the selected social media platforms before publication. Platform-specific previews show accurate representations including text formatting, image display, hashtag styling, and link previews as they will appear on Instagram, Facebook, Twitter, or other platforms. This preview capability ensures users can assess post effectiveness and make adjustments before publishing.

The interface includes direct posting capabilities that publish posts to connected social media accounts immediately or according to scheduled times. Users may authenticate their social media accounts through OAuth or similar secure authorization protocols, granting the system permission to post on their behalf. The system interfaces with social media platform APIs to publish posts programmatically, eliminating the need for users to manually copy content and paste it into multiple platforms separately.

Alternative workflow options accommodate users who prefer manual posting or cannot connect social media accounts due to platform restrictions or security policies. The interface provides export or copy functions allowing users to extract post content for manual pasting into social media platforms. Platform-specific formatting is preserved or adapted for manual entry compatibility.

Post performance tracking integrates with analytics dashboard 606 described in connection with FIG. 6, displaying engagement metrics for published posts. Metrics may include likes, comments, shares, click-through rates to the website, reach or impressions, and conversion data when visitors who arrive via social media subsequently click purchase links. Performance data informs future post recommendations, with the system learning which post types, topics, timing, and formats generate the best engagement for the specific user and audience.

The interface may present historical post archives showing previously created or published posts, allowing users to review past content, republish successful posts, or maintain consistent messaging over time. Archive search and filtering capabilities enable users to locate specific posts by date, platform, commodity, or keyword.

Batch creation and management tools enable users to generate multiple related posts simultaneously. For example, when adding a new commodity to the website through commodity detail editing interface 1000, the system might automatically generate a series of promotional posts announcing the new addition from different angles: initial announcement, feature highlights, review excerpts, and purchase calls to action. Users can review, customize, and schedule this batch of related posts efficiently.

Template and campaign management capabilities allow users to create reusable post templates for providing recurring content. Templates might define standard formatting, hashtag sets, or content structures for specific post types such as weekly book features, author Q&A sessions, or seasonal promotions. Campaigns group related posts around specific objectives such as new release launches, providing coordinated multi-post strategies with suggested timing and sequencing.

Integration with website monitoring capabilities described in connection with decision point 224 and stage 226 of FIG. 2 enables automated post generation when new commodities or updates are detected. For example, when the system identifies a newly published book by the author through automated monitoring of data sources, it may automatically generate social media post recommendations announcing the new release, streamlining promotional efforts.

Collaboration features in certain embodiments allow multiple users to access the interface, such as authors working with marketing assistants, publicists, or social media managers. Approval workflows may require designated users to review and approve posts before publication, ensuring quality control while enabling delegation of content creation tasks.

The social media post recommendation interface 1100 reduces the time, effort, and expertise required for effective social media marketing. By automatically generating relevant, well-formatted post content based on commodity information and website content, the interface enables users to maintain active, engaging social media presences that drive traffic to their websites and promote commodity sales. Users without social media marketing expertise benefit from intelligent recommendations incorporating best practices, while experienced users benefit from efficiency gains and creative inspiration. The integration of post generation, customization, scheduling, and analytics within a unified interface streamlines the complete social media content lifecycle, supporting the website's broader objectives of audience building and commodity promotion.

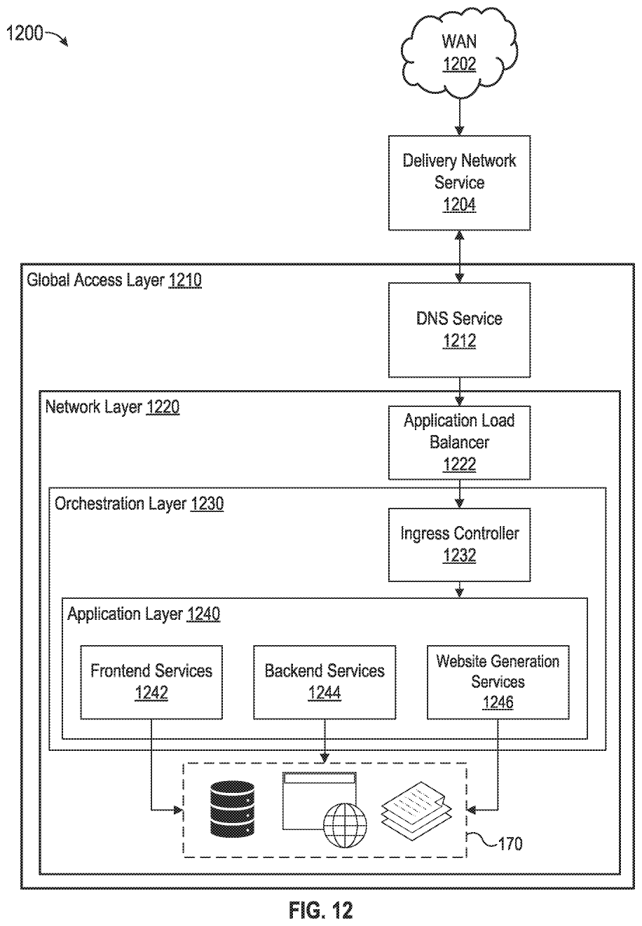

FIG. 12 illustrates an example of an infrastructure architecture 1200 for implementing website generation system 150. Infrastructure architecture 1200 depicts a multi-tier distributed computing architecture that provides scalability, reliability, security, and performance for the automated website generation and hosting services described throughout this disclosure. The architecture employs modern cloud-native design principles including load balancing, service orchestration, content delivery optimization, and redundancy to ensure high availability and responsiveness for users worldwide.

The infrastructure architecture 1200 includes layers representing logical and physical separation of system components according to their functions, with each layer providing specific capabilities that collectively enable the complete website generation and hosting platform. Data and requests flow through the layers in coordinated sequences, with each layer performing designated processing, routing, security, or transformation operations.

WAN 1202 represents the public Internet or other wide area network infrastructure through which users access the website generation system 150 and through which generated websites are delivered to visitors. WAN 1202 provides global connectivity enabling computing device 110 described in connection with FIG. 1 to communicate with the system infrastructure regardless of geographic location. WAN 1202 encompasses the diverse network paths, internet service providers, telecommunications infrastructure, and routing systems that constitute modern internet connectivity.

Content delivery network service 1204 provides distributed content caching and delivery optimization. Content delivery network service 1204 may comprise a network of geographically distributed edge servers that cache static website content, images, stylesheets, JavaScript files, and other assets at locations proximate to end users. When visitors access generated websites, content delivery network service 1204 serves cached content from the nearest edge location, reducing latency, accelerating page load times, and decreasing bandwidth consumption on origin servers.

In certain embodiments, content delivery network service 1204 implements intelligent caching policies that determine which content is cached, for how long, and under what conditions cached content is refreshed. Dynamic content requiring real-time generation may bypass caching, while static assets such as book cover images, user profile photographs, or theme stylesheets are cached with extended expiration times. Content delivery network service 1204 may also provide security capabilities including DDoS (Distributed Denial of Service) attack mitigation, bot filtering, and SSL/TLS certificate management for secure HTTPS connections.

Content delivery network service 1204 may be implemented using commercial content delivery network providers or may be implemented through custom-built edge caching infrastructure. The distributed nature of content delivery network service 1204 ensures that generated websites load quickly for visitors worldwide regardless of the physical location of the origin infrastructure hosting the website generation system 150.

Global access layer 1210 provides foundational internet services enabling discovery and access to the system infrastructure. This layer handles domain name resolution, traffic routing, and initial request direction that connects users and visitors to the appropriate system resources.

DNS service 1212 translates human-readable domain names into IP addresses required for network routing. DNS service 1212 maintains DNS records for the website generation platform's own domains (such as the domain hosting the user interfaces described in FIG. 3 through FIG. 11) and for the generated websites published through the system. When a user configures a custom domain as described in connection with FIG. 5, DNS service 1212 is configured with appropriate DNS records pointing the custom domain to the infrastructure hosting the generated website.

In certain embodiments, DNS service 1212 implements geographic load balancing or latency-based routing, directing requests to infrastructure regions that provide optimal performance for the requesting user's location. DNS service 1212 may also provide DNS-level security features such as DNSSEC (DNS Security Extensions) for authentication and integrity verification, protection against DNS spoofing or cache poisoning attacks, and DNS-based filtering or rate limiting.

Global access layer 1210 may include additional components such as global traffic management services that monitor infrastructure health and route traffic away from degraded or failed components, geographic traffic steering that directs users to regional infrastructure deployments based on location, and analytics services that collect high-level traffic metrics for capacity planning and security monitoring.

Network layer 1222 provides request routing, load distribution, and network-level processing for traffic entering the application infrastructure. This layer receives requests from the global access layer 1210 and content delivery network service 1204, distributing them across multiple application instances to ensure no single instance becomes overwhelmed.

Application load balancer 1224 distributes incoming requests across multiple instances of application services, ensuring balanced resource utilization and providing redundancy if individual instances fail. Application load balancer 1224 operates at OSI Layer 7 (application layer), understanding HTTP/HTTPS protocols and making routing decisions based on request characteristics such as URL paths, HTTP headers, cookies, or request methods.

In certain embodiments, application load balancer 1224 implements intelligent routing algorithms including round-robin distribution that cycles requests across available instances sequentially, least-connections routing that directs requests to instances with the fewest active connections, response-time routing that favors instances responding most quickly, or session affinity (sticky sessions) that ensures requests from the same user session route to the same application instance for stateful operations.

Application load balancer 1224 performs health checking of application instances, continuously monitoring whether instances are responding correctly to requests. Unhealthy instances are automatically removed from the load balancing pool until they recover, preventing requests from being routed to failed or degraded services. This health monitoring ensures high availability even when individual components experience failures.

SSL/TLS termination may be performed at application load balancer 1224, where encrypted HTTPS connections from users are decrypted, inspected, and potentially re-encrypted for transmission to backend services. This offloading of cryptographic operations from application instances improves performance and centralizes certificate management.

Network layer 1222 may include additional components such as web application firewalls (WAF) that filter malicious requests, protect against common web exploits (such as SQL injection or cross-site scripting), and enforce security policies, network security groups or firewalls that restrict traffic to only authorized protocols and ports, DDoS protection services that detect and mitigate volumetric attacks, and network monitoring and logging systems that capture traffic patterns for security analysis and performance optimization.

Orchestration layer 1230 provides container orchestration, service discovery, configuration management, and traffic routing within the application infrastructure. This layer coordinates the deployment, scaling, and management of application services, abstracting the complexity of distributed systems from individual application components.

Ingress controller 1232 manages external access to services running within a container orchestration platform such as Kubernetes. Ingress controller 1232 receives traffic from application load balancer 1224 and routes requests to appropriate services based on routing rules, URL paths, hostnames, or other request attributes. For example, requests for the website configuration interfaces may be routed to frontend services 1242, while API requests for data retrieval or website generation may be routed to backend services 1244 or website generation services 1246.

Ingress controller 1232 implements routing configurations that map external URLs to internal services, enabling a unified external interface while maintaining service separation internally. The controller may perform additional functions including request authentication and authorization, rate limiting to prevent abuse, request/response transformation or header manipulation, canary deployments routing a percentage of traffic to new service versions for testing, and SSL/TLS management for service-to-service encryption.

Orchestration layer 1230 includes additional components that manage the application infrastructure. Container orchestration platform provides automated deployment, scaling, and management of containerized applications. The orchestration platform schedules application containers onto available compute nodes, monitors container health, automatically restarts failed containers, and scales services horizontally by adding or removing container instances based on load.

Service mesh technologies may be implemented within orchestration layer 1230, providing service-to-service communication management, traffic routing policies, observability through distributed tracing, and security through mutual TLS authentication between services.

Configuration management services store and distribute configuration parameters, secrets, and environment variables to application services securely. Service discovery mechanisms enable services to locate and communicate with each other dynamically without hardcoded addresses. As services scale up or down and instances are created or destroyed, service discovery registries maintain current service locations, enabling resilient inter-service communication.

Application layer 1240 contains the core business logic and functionality implementing the website generation capabilities described throughout this disclosure. Services within this layer process user requests, retrieve commodity data, generate websites, manage content, and provide user interfaces. Application layer 1240 is designed with microservices architecture principles, separating functionality into distinct, independently deployable services that communicate through well-defined APIs.

Frontend services 1242 provide the user interfaces and client-facing functionality for the website generation platform. Frontend services 1242 serve the user interfaces illustrated in FIG. 3 through FIG. 11, including commodity identifier input interfaces, theme selection interfaces, website configuration interfaces, preview interfaces, editing controls, and analytics dashboards.

Frontend services 1242 handle user authentication and session management, ensuring authorized access to website management capabilities. Users create accounts, log in through authentication mechanisms (including username/password, social login, or multi-factor authentication), and receive session tokens or cookies that authenticate subsequent requests. Frontend services 1242 communicate with backend services 1244 through RESTful APIs, GraphQL endpoints, or other API protocols to retrieve data, submit user inputs, and trigger backend operations.

In certain embodiments, frontend services 1242 implement progressive web application (PWA) capabilities, enabling offline functionality, push notifications, or installable applications that enhance user experience. Responsive design ensures interfaces function effectively across desktop, tablet, and mobile devices as described in connection with FIG. 5.

Backend services 1244 provide the core application logic, data management, and business rule enforcement for the website generation platform. Backend services 1244 may be decomposed into multiple specialized microservices including user management services handling user accounts, authentication, authorization, and profile management, commodity management services implementing the functionality described in FIG. 9 and FIG. 10 for organizing and editing commodity information, content management services handling user biographical information and website content, purchase link services implementing the functionality described in FIG. 8, analytics services collecting and aggregating the metrics displayed in analytics dashboard 606 (FIG. 6), and social media integration services implementing the functionality described in FIG. 11 for social media post generation and publishing.

Backend services 1244 implement API endpoints that frontend services 1242 and other components call to perform operations. These APIs handle request validation, business logic execution, data persistence operations, and response formatting. Services may communicate synchronously through HTTP/REST APIs or GraphQL, or asynchronously through message queues or event streams for operations that don't require immediate responses.

Backend services 1244 interact with databases storing persistent data including user accounts, commodity information, website configurations, analytics data, and system metadata. Databases may include relational databases such as PostgreSQL or MySQL for structured data requiring transactional consistency, NoSQL databases such as MongoDB or DynamoDB for flexible document storage, cache databases such as Redis or Memcached for high-speed data access, and search engines such as Elasticsearch for full-text search capabilities.

Website generation services 1246 implement the automated website generation functionality. Website generation services 1246 execute the processes described in connection with FIG. 2, performing commodity information retrieval (stage 212), user disambiguation, theme and layout recommendation (stage 218), and complete website generation (stage 220).

Website generation services 1246 include data aggregation components that query data sources 170 to retrieve commodity information, user profile data from social media, reviews, and other relevant information. These components implement the functionality of data aggregation module 154 described in connection with FIG. 1, interfacing with external APIs, scraping web content where APIs are unavailable, and normalizing retrieved data into consistent formats.

Recommendation engine components within website generation services 1246 analyze commodity information and user characteristics to generate theme and layout recommendations as described in connection with recommendation engine 158 (FIG. 1) and stage 218 (FIG. 2). These components may employ machine learning models trained on successful website designs, rule-based logic encoding design best practices, or hybrid approaches combining statistical analysis with expert rules.

Website rendering components within website generation services 1246 generate complete, functional websites from commodity data, user profiles, and selected themes. These components implement the functionality of website generation engine 160 described in connection with FIG. 1. The rendering process includes applying theme styles and layouts, populating content templates with retrieved data, generating HTML, CSS, and JavaScript code, configuring navigation structures, integrating functional elements such as contact forms and purchase links, optimizing images and assets for web delivery, and generating responsive designs that adapt to different devices.

Generated websites may be deployed as static site generation (SSG) producing pre-rendered HTML files served efficiently through content delivery network service 1204, server-side rendering (SSR) generating pages dynamically in response to visitor requests, or hybrid approaches combining static pages for content-heavy sections with dynamic rendering for interactive features.

Monitoring and update services within website generation services 1246 implement the functionality described in connection with decision point 224 and stage 226 of FIG. 2, periodically querying data sources 170 to identify new commodities, updated information, or changes requiring website updates. When updates are identified, the services trigger regeneration of affected website sections and deploy updates to published websites automatically or pending user approval.

Data sources 170, as described in connection with FIG. 1, comprise external data sources, APIs, and services from which the system retrieves commodity information, user profile data, reviews, and other content. Data sources 170 exist outside the infrastructure architecture 1200 but are accessed by application layer services through network connections. Data sources may include book databases and APIs such as Google Books API, Open Library, Goodreads, or proprietary publisher databases, retail platform APIs from Amazon, Barnes & Noble, or other merchants, social media platform APIs from Instagram, Facebook, Twitter, or other social networks, review aggregation services, and public or proprietary databases containing commodity metadata.

Application layer 1240 may include additional services such as notification services sending email notifications, SMS messages, or push notifications to users regarding website updates, visitor analytics, or system events, billing and subscription services managing user payments, subscription tiers, and usage tracking, job processing services executing long-running operations asynchronously such as bulk commodity imports or comprehensive website regenerations, and logging and monitoring services collecting application logs, performance metrics, and error reports for operational visibility and debugging.

The infrastructure architecture 1200 implement comprehensive security measures across all layers including encryption in transit using TLS/SSL for all network communications, encryption at rest for stored data including databases and file storage, identity and access management (IAM) controlling which services and users can access specific resources, network segmentation isolating services and restricting communication to necessary paths, security scanning and vulnerability assessment identifying potential security issues, intrusion detection and prevention systems monitoring for malicious activity, and regular security updates and patch management maintaining current security postures.

Scalability is achieved through horizontal scaling where additional service instances are deployed automatically in response to increased load, stateless service design enabling any instance to handle any request without dependencies on specific instances, database scaling through replication, sharding, or managed database services that handle scaling automatically, caching strategies reducing database load and accelerating responses, and asynchronous processing offloading heavy operations to background jobs that don't impact user-facing response times.

Observability and operational management include centralized logging aggregating logs from all services for analysis and troubleshooting, distributed tracing tracking requests across service boundaries to identify performance bottlenecks, metrics collection and visualization through dashboards showing system health and performance, alerting systems notifying operators of anomalies, failures, or degraded performance, and automated remediation executing predefined recovery actions in response to common failure scenarios.

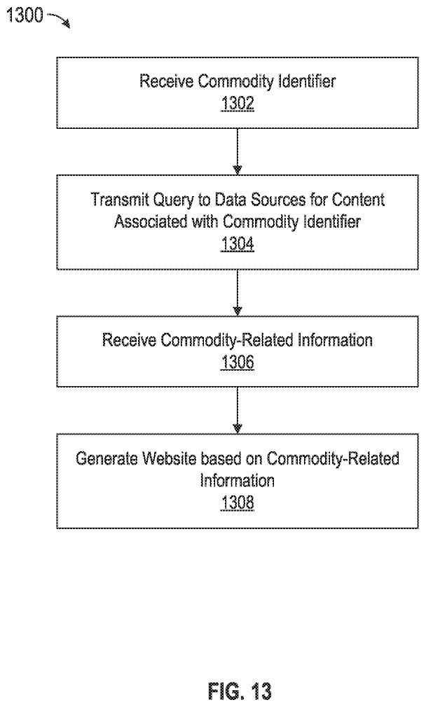

FIG. 13 is a flowchart illustrating a method 1300 for automated website generation. The method 1300 begins at stage 1302, where a commodity identifier for a commodity associated with a user is received via a user interface. A processor executing instructions on a storage media comprises an example means for performing stage 1302.

At stage 1304, a query is transmitted via a computer network to one or more data sources for content associated with the commodity identifier. A processor executing instructions on a storage media comprises an example means for performing stage 1304.

At stage 1306, in response to the query, commodity-related information is received from the one or more data sources. A processor executing instructions on a storage media comprises an example means for performing stage 1306.

At stage 1308, a custom website for the user is automatically generated based on the commodity-related information, wherein the custom website includes content derived from the commodity-related information. Manual entry of the content by the user is not required. A processor executing instructions on a storage media comprises an example means for performing stage 1308. In example implementations, the commodity identifier is a unique book identifier (e.g., ISBN, EAN, book title, URL), the commodity is a book, and the user is an author.

Transmitting the query to the one or more data sources may further comprise querying for user-associated content, and receiving the commodity-related information may further comprise receiving user-related information from the one or more data sources, wherein the custom website is further based on the user-related information.

Optionally, automatically generating the custom website may comprise automatically selecting a website template from a plurality of available templates based on characteristics of the commodity identified in the commodity-related information.

The method 1300 may include identifying one or more additional commodities associated with the user and retrieving, from the one or more data sources, additional commodity-related information related to the one or more additional commodities, wherein the custom website is further based on the additional commodity-related information. The commodity may be a book, and the commodity identifier may be an ISBN.

The method 1300 can include analyzing user-generated user-associated content to identify a writing style of the user. Automatically generating the custom website can include automatically drafting website content components based on the writing style.

The method 1300 may include periodically monitoring the one or more data sources for updated information associated with the commodity identifier and automatically updating the custom website based on the updated information.

The method 1300 may include receiving, via the user interface, social media information associated with the user and retrieving social media user-associated content from one or more social media platforms based on the social media information, wherein the custom website is further based on the social media content.

Automatically generating the custom website may comprise: selecting a theme for the custom website based on the commodity-related information; determining a layout for the custom website including a plurality of sections comprising a user information section and a commodity information section; populating the user information section with biographical information about the user retrieved from the one or more data sources; populating the commodity information section with commodity details including a title, description, and images associated with the commodity retrieved from the one or more data sources; generating purchase links in the commodity information section, wherein the purchase links direct visitors to one or more online retailers offering the commodity for sale; and configuring navigation elements to enable access to each of the plurality of sections.

The method 1300 may include generating a social media post recommendation based on one or more of the commodity-related information, user-related information retrieved from the one or more data sources, or a social media profile of the user.

In an example, a computer-implemented method for automated website generation is provided, the method comprising: receiving, via a user interface, a commodity identifier for a commodity associated with a user; transmitting a query via a computer network to one or more data sources for content associated with the commodity identifier; receiving, in response to the query, commodity-related information from the one or more data sources; and automatically generating a custom website for the user based on the commodity-related information, wherein the custom website includes content derived from the commodity-related information.

In some embodiments, transmitting the query to the one or more data sources further comprises querying for user-associated content; receiving, in response to the query, the commodity-related information further comprises receiving user-related information from the one or more data sources; and automatically generating the custom website for the user is further based on the user-related information. In certain embodiments, automatically generating the custom website comprises automatically selecting a website template from a plurality of available templates based on characteristics of the commodity identified in the commodity-related information.

In some embodiments, the method further comprises identifying one or more additional commodities associated with the user; and retrieving, from the one or more data sources, additional commodity-related information related to the one or more additional commodities, wherein automatically generating the custom website for the user is further based on the additional commodity-related information. In certain embodiments, the commodity is a book. In some embodiments, the commodity identifier is an International Standard Book Number.

In some embodiments, the method further comprises periodically monitoring the one or more data sources for updated information associated with the commodity identifier; and automatically updating the custom website based on the updated information. In certain embodiments, the method further comprises receiving, via the user interface, social media information associated with the user; and retrieving social media user-associated content from one or more social media platforms based on the social media information, wherein automatically generating the custom website for the user is further based on the social media content. The method can further include analyzing user-generated user-associated content to identify a writing style of the user; and wherein automatically generating the custom website comprises automatically drafting website content components based on the writing style.

In some embodiments, automatically generating the custom website comprises: selecting a theme for the custom website based on the commodity-related information; determining a layout for the custom website including a plurality of sections comprising a user information section, and a commodity information section; populating the user information section with biographical information about the user retrieved from the one or more data sources; populating the commodity information section with commodity details including a title, description, and images associated with the commodity retrieved from the one or more data sources; and generating purchase links in the commodity information section, wherein the purchase links direct visitors to one or more online retailers offering the commodity for sale; and configuring navigation elements to enable access to each of the plurality of sections. In certain embodiments, the method further comprises generating a social media post recommendation based on one or more of the commodity-related information, user-related information retrieved from the one or more data sources, or a social media profile of the user.

In another example, a system for automated website generation is provided, the system comprising: a processor; and a memory storing instructions that, when executed by the processor, cause the system to: receive, via a user interface, a commodity identifier for a commodity associated with a user; transmit a query via a computer network to one or more data sources for content associated with the commodity identifier; receive, in response to the query, commodity-related information from the one or more data sources; and automatically generate a custom website for the user based on the commodity-related information, wherein the custom website includes content derived from the commodity-related information.

In some embodiments, the instructions further cause the system to: transmit the query to the one or more data sources by querying for user-associated content; receive user-related information from the one or more data sources in response to the query; and automatically generate the custom website for the user further based on the user-related information. In certain embodiments, the instructions that cause the system to automatically generate the custom website further cause the system to automatically select a website template from a plurality of available templates based on characteristics of the commodity identified in the commodity-related information. The instructions can further cause the system to analyze user-generated user-associated content to identify a writing style of the user; and wherein to automatically generate the custom website comprises to automatically draft website content components based on the writing style.

In some embodiments, the instructions further cause the system to: identify one or more additional commodities associated with the user; and retrieve, from the one or more data sources, additional commodity-related information related to the one or more additional commodities, wherein the custom website is generated further based on the additional commodity-related information. In certain embodiments, the commodity is a book; and the commodity identifier is an International Standard Book Number.

In some embodiments, the instructions further cause the system to: periodically monitor the one or more data sources for updated information associated with the commodity identifier; and automatically update the custom website based on the updated information. In certain embodiments, the instructions further cause the system to: receive, via the user interface, social media information associated with the user; and retrieve social media user-associated content from one or more social media platforms based on the social media information, wherein the custom website is generated further based on the social media content.

In some embodiments, the instructions that cause the system to automatically generate the custom website further cause the system to: select a theme for the custom website based on the commodity-related information; determine a layout for the custom website including a plurality of sections comprising a user information section and a commodity information section; populate the user information section with biographical information about the user retrieved from the one or more data sources; populate the commodity information section with commodity details including a title, description, and images associated with the commodity retrieved from the one or more data sources; generate purchase links in the commodity information section, wherein the purchase links direct visitors to one or more online retailers offering the commodity for sale; and configure navigation elements to enable access to each of the plurality of sections.

In certain embodiments, the instructions further cause the system to generate a social media post recommendation based on one or more of the commodity-related information, user-related information retrieved from the one or more data sources, or a social media profile of the user.

In yet another example, a non-transitory computer-readable medium storing instructions is provided that, when executed by a processor, cause the processor to perform operations comprising: receiving, via a user interface, a commodity identifier for a commodity associated with a user; transmitting a query via a computer network to one or more data sources for content associated with the commodity identifier; receiving, in response to the query, commodity-related information from the one or more data sources; and automatically generating a custom website for the user based on the commodity-related information, wherein the custom website includes content derived from the commodity-related information

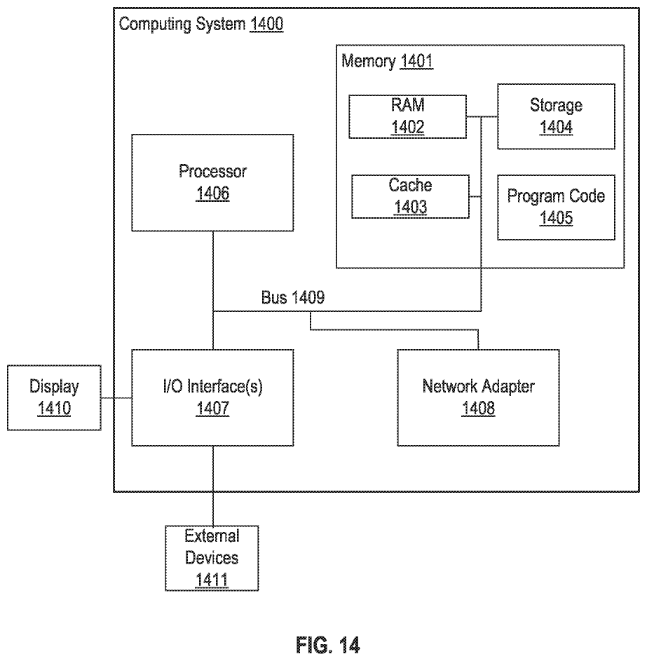

FIG. 14 illustrates a computing system 1400 for implementing the various embodiments described above. The computing system 1400 is operationally coupled to a processor 1406, a memory 1401, and a bus 1409 that couples various system components, including the memory 1401 to the processor 1406. The bus 1409 represents one or more of any of several types of bus structure, including a memory bus or memory controller, a peripheral bus, an accelerated graphics port, and a processor or local bus using any of a variety of bus architectures. The memory 1401 may include computer readable media in the form of volatile memory, such as random access memory (RAM) 1402 or cache memory 1403, or non-volatile storage media 1404. The memory 1401 may include at least one program product having a set of at least one program code module 1405 that are configured to carry out various functions described herein when executed by the processor 1406. The computing system 1400 may also communicate with one or more external devices 1411, such as a display 1410, via I/0 interfaces 1407. The computing system 1400 may communicate with one or more networks via network adapter 1408. The infrastructure architecture 1200 provides a robust, scalable, secure, and performant foundation for delivering the automated website generation capabilities described throughout this disclosure. The layered architecture enables independent scaling and evolution of different system components while maintaining overall system cohesion. Users experience fast, reliable access to website generation tools regardless of location or load, while generated websites benefit from global content delivery and high availability ensuring visitor access at all times. The infrastructure design accommodates growth from initial deployments serving small user bases through massive scaling supporting millions of users and generated websites.

The example embodiments described herein may be implemented using hardware, software, or a combination thereof and may be implemented in one or more computer systems or other processing systems. However, the manipulations performed by these example embodiments may have been referred to in terms which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, which may include an article of manufacture on a machine accessible or non-transitory computer-readable medium (i.e., also referred to as “machine readable medium”) having instructions. The instructions on the machine accessible or machine-readable medium may be used to program a computer system or other electronic device. The machine-readable medium may include, but is not limited to, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A computer-implemented method for automated website generation, the method comprising:
receiving, via a user interface, a unique book identifier for a book associated with an author;
transmitting a query via a computer network to one or more data sources for content associated with the unique book identifier;
receiving, in response to the query, book-related information from the one or more data sources; and
automatically generating a custom website for the author based on the book-related information, wherein the custom website includes content derived from the book-related information.

2. The method of claim 1, wherein:
transmitting the query to the one or more data sources further comprises querying for author-associated content;
receiving, in response to the query, the book-related information further comprises receiving author-related information from the one or more data sources; and
automatically generating the custom website for the author is further based on the author-related information.

3. The method of claim 1, wherein automatically generating the custom website comprises:
automatically selecting a website template from a plurality of available templates based on characteristics of the book identified in the book-related information.

4. The method of claim 1, further comprising:
performing author disambiguation to identify one or more additional books associated with the author; and
retrieving, from the one or more data sources, additional book-related information for the one or more additional books,
wherein automatically generating the custom website for the author is further based on the additional book-related information.

5. The method of claim 4, wherein performing author disambiguation comprises:
analyzing genre information for books having author names that match or are similar to the author;
analyzing publication timing patterns for books having author names that match or are similar to the author;
analyzing publisher relationships for books having author names that match or are similar to the author; and
determining whether the books should be associated with the author based on the analyzed genre information, publication timing patterns, and publisher relationships.

6. The method of claim 5, wherein determining whether the books should be associated with the author comprises:
calculating a confidence score based on weighted contributions from the genre information, publication timing patterns, and publisher relationships; and
associating books with the author when the confidence score exceeds a predetermined threshold.

7. The method claim 1, wherein:
the unique book identifier is an International Standard Book Number, a European Article Number, a book title, or a Uniform Resource Locator.

8. The method of claim 1, further comprising:
analyzing author-generated content to identify a writing style of the author; and
wherein automatically generating the custom website comprises automatically drafting website content components based on the writing style.

9. The method of claim 1, further comprising:
receiving, via the user interface, social media information associated with the author; and
retrieving social media author-associated content from one or more social media platforms based on the social media information,
wherein automatically generating the custom website for the author is further based on the social media content.

10. The method of claim 1, wherein automatically generating the custom website comprises:
selecting a theme for the custom website based on the book-related information;
determining a layout for the custom website including a plurality of sections comprising an author information section, and a book information section;
populating the author information section with biographical information about the author retrieved from the one or more data sources;
populating the book information section with book details including a title, description, and images associated with the book retrieved from the one or more data sources;
generating purchase links in the book information section, wherein the purchase links direct visitors to one or more online retailers offering the book for sale; and
configuring navigation elements to enable access to each of the plurality of sections.

11. The method of claim 1, further comprising:
generating a social media post recommendation based on at least one of (1) the book-related information, (2) author-related information retrieved from the one or more data sources, or (3) a social media profile of the author.

12. A system for automated website generation, the system comprising:
a processor; and
a memory storing instructions that, when executed by the processor, cause the system to:
receive, via a user interface, a unique book identifier for a book associated with an author;
transmit a query via a computer network to one or more data sources for content associated with the unique book identifier;
receive, in response to the query, book-related information from the one or more data sources; and
automatically generate a custom website for the author based on the book-related information, wherein the custom website includes content derived from the book-related information.

13. The system of claim 12, wherein the instructions further cause the system to:
transmit the query to the one or more data sources by querying for author-associated content;
receive author-related information from the one or more data sources in response to the query; and
automatically generate the custom website for the author further based on the author-related information.

14. The system of claim 12, wherein the instructions that cause the system to automatically generate the custom website further cause the system to:
automatically select a website template from a plurality of available templates based on characteristics of the book identified in the book-related information.

15. The system of claim 12, wherein the instructions further cause the system to:
perform author disambiguation to identify one or more additional books associated with the author; and
retrieve, from the one or more data sources, additional book-related information for the one or more additional books,
wherein to automatically generate the custom website for the author is further based on the additional book-related information.

16. The system of claim 15, wherein to perform author disambiguation comprises to:
analyze genre information for books having author names that match or are similar to the author;
analyze publication timing patterns for books having author names that match or are similar to the author;
analyze publisher relationships for books having author names that match or are similar to the author; and
determine whether the books should be associated with the author based on the analyzed genre information, publication timing patterns, and publisher relationships.

17. The system of claim 12, wherein the instructions further cause the system to:
analyze author-generated content to identify a writing style of the author; and
wherein to automatically generate the custom website comprises to automatically draft website content components based on the writing style.

18. The system of claim 12, wherein the instructions further cause the system to:
receive, via the user interface, social media information associated with the author; and
retrieve social media author-associated content from one or more social media platforms based on the social media information,
wherein the custom website is generated further based on the social media content.

19. The system of claim 12, wherein the instructions that cause the system to automatically generate the custom website further cause the system to:
select a theme for the custom website based on the book-related information;
determine a layout for the custom website including a plurality of sections comprising an author information section and a book information section;
populate the author information section with biographical information about the author retrieved from the one or more data sources;
populate the book information section with book details including a title, description, and images associated with the book retrieved from the one or more data sources;
generate purchase links in the book information section, wherein the purchase links direct visitors to one or more online retailers offering the book for sale; and
configure navigation elements to enable access to each of the plurality of sections.

20. A non-transitory computer-readable medium storing instructions that, when executed by a processor, cause the processor to perform operations comprising:
receiving, via a user interface, a unique book identifier for a book associated with an author;
transmitting a query via a computer network to one or more data sources for content associated with the unique book identifier;
receiving, in response to the query, book-related information from the one or more data sources; and
automatically generating a custom website for the author based on the book-related information, wherein the custom website includes content derived from the book-related information.
